(19) United States
(12) Patent Application Publication
(10) Pub. No.: US 2026/0334426 A1
(43) Pub. Date: Oct. 29, 2026

(54) PET TOILET

(71) Applicant: PetPivot INC, PORTLAND, OR (US)

(72) Inventor: XIAOXIANG TANG, Shenzhen, Guangdong (CN)

(21) Appl. No.: 19/731,982

(22) Filed: Jul. 6, 2026

Related U.S. Application Data
(63) Continuation-in-part of application No. 19/634,057, filed on Mar. 30, 2026.
Application No. 19/634,057 is a continuation of application No. 18/431,475, filed on Feb. 2, 2024, now Pat. No. 12,610,921.
Application No. 18/431,475 is a continuation-in-part of application No. 18/541,428, filed on Dec. 15, 2023, now Pat. No. 12,616,163.

(30) Foreign Application Priority Data
Nov. 24, 2023 (CN) 202323196077.4
Jan. 26, 2024 (CN) 202420199695.X
Jun. 18, 2026 (CN) 202620922588.4

(51) Int. Cl. A01K 1/01

(52) U.S. Cl. CPC A01K 1/0114

(57) ABSTRACT

A pet toilet includes a base. The base is provided with a surrounding wall extending downward from a peripheral edge of a second opening. A mounting cavity for accommodating electronic components is surrounded and defined by the surrounding wall and a bottom wall of the base. The surrounding wall is provided with a mounting structure, and the mounting structure is configured for mounting a waste collection box. When the waste collection box is connected to the mounting structure, a collection opening of the waste collection box is in communication with the second opening. The surrounding wall cooperates with an outer side wall of the waste collection box to isolate the mounting cavity from a waste collection space of the waste collection box and the second opening.

### CROSS-REFERENCE TO RELATED APPLICATIONS

This application is a continuation in part of U.S. application serial No. 19/634, 057, filed on Mar. 30, 2026, which is a continuation in part of U.S. application serial No. 18/431, 475, filed on Feb. 2, 2024, now U.S. Pat. No. 12,610,921, which is a continuation in part of U.S. application serial No. 18/541, 428, now U.S. Pat. No. 12,616,163, filed on Dec. 15, 2023, the content of which is incorporated by reference herein. The application claims priority of Chinese patent application CN2026209225884, filed on Jun 18, 2026, disclosure of which is incorporated herein by reference in its entirety.

### TECHNICAL FIELD

The present disclosure relates to the field of pet toilets, and in particular to a pet toilet.

### BACKGROUND

Current pet toilets mostly employ common containers, such as litter boxes. The litter boxes are filled with cat litter for pets to defecate. However, after defecation, pet owners are required to clean the excreta, which is time-consuming and labor-intensive. Moreover, the excreta in the litter boxes produces odors that are often unacceptable to the owners. Therefore, there is an urgent need on the market for an intelligent litter box capable of automatically cleaning feces, so as to improve user experience.

### SUMMARY

In order to overcome the shortcomings of the existing technology, the present disclosure provides a pet toilet.

The pet toilet includes a roller. The roller is provided with a first opening and a first accommodating space, and the first opening is in communication with the first accommodating space. The first accommodating space is configured for accommodating excreta of pets and pet litter.

The pet toilet further includes a base. The roller is supported by the base, and the base is further provided with a second opening.

The pet toilet further includes a sifting assembly. The sifting assembly is connected to the roller. A second accommodating space is surrounded and defined by the sifting assembly and an inner wall of the roller. The second accommodating space is adjacent to the first accommodating space. The sifting assembly is configured for separating the pet litter from the excreta.

The pet toilet further includes a driving device. The driving device is configured for driving the roller to rotate on the base. When the first opening rotates along with the roller from an initial position to a discharge position, the pet litter is capable of entering the second accommodating space through the sifting assembly, and the excreta is confined outside the second accommodating space. The first opening is configured to rotate along with the roller to be aligned with the second opening, and the first opening is in communication with the second opening, thereby allowing the excreta to be discharged through the first opening and the second opening under its own gravity. When the first opening rotates along with the roller from the discharge position to the initial position, the first opening is misaligned with the second opening, and the second opening is covered by the roller. In addition, the pet litter inside the second accommodating space is capable of passing through the sifting assembly and falling back into the first accommodating space under its own gravity.

The base is provided with a surrounding wall extending downward from a peripheral edge of the second opening. A mounting cavity for accommodating electronic components is surrounded and defined by the surrounding wall and a bottom wall of the base. The surrounding wall is provided with a mounting structure, and the mounting structure is configured for mounting a waste collection box. When the waste collection box is connected to the mounting structure, a collection opening of the waste collection box is in communication with the second opening. The surrounding wall cooperates with an outer side wall of the waste collection box to isolate the mounting cavity from a waste collection space of the waste collection box and the second opening, thereby preventing gas in the waste collection space from entering the mounting cavity.

Beneficial effects of the present disclosure are as follows. The present disclosure provides a pet toilet. The pet toilet includes a base, and the base is provided with a surrounding wall extending downward from a peripheral edge of the second opening. A mounting cavity for accommodating electronic components is surrounded and defined by an outer side wall of the surrounding wall and a bottom wall of the base. The surrounding wall is provided with a mounting structure, and the mounting structure is configured for mounting a waste collection box. When the waste collection box is connected to the mounting structure, a collection opening of the waste collection box is in communication with the second opening. The surrounding wall cooperates with an outer side wall of the waste collection box to isolate the mounting cavity from a waste collection space of the waste collection box and the second opening, thereby preventing gas in the waste collection space from entering the mounting cavity. Through the aforementioned structure, when the waste collection box is mounted at the base, the outer side wall of the surrounding wall cooperates with the outer side wall of the waste collection box, so as to isolate the mounting cavity from the waste collection space of the waste collection box and the second opening. This can effectively prevent odorous gas and moisture generated in the waste collection space from entering the mounting cavity, and further can reduce the risk of contamination, dampness, and corrosion of the electronic components, thereby improving the operational stability and service life of the electronic components.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an overall structural schematic view of a roller of the present disclosure in an initial position;

FIG. 2 is an overall structural schematic view of the roller of the present disclosure in a discharge position;

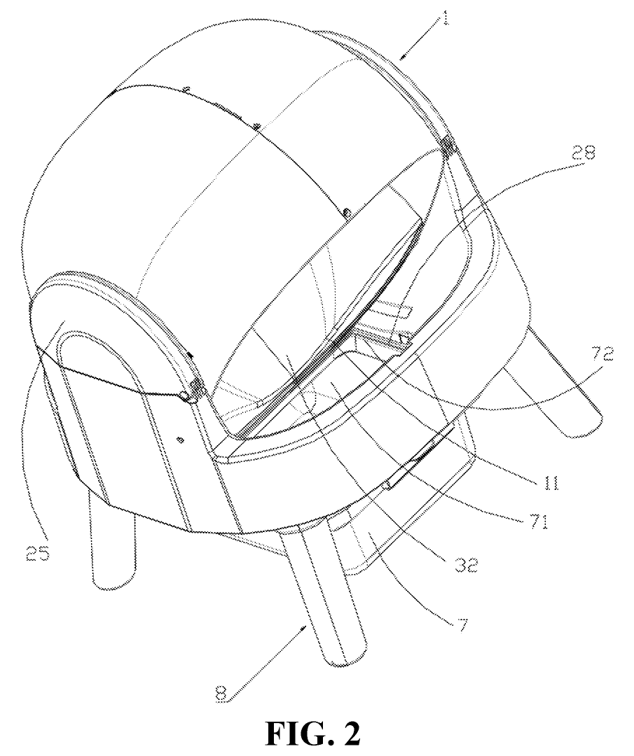

FIG. 3 is a sectional view taken along the roller when the roller is in the initial position;

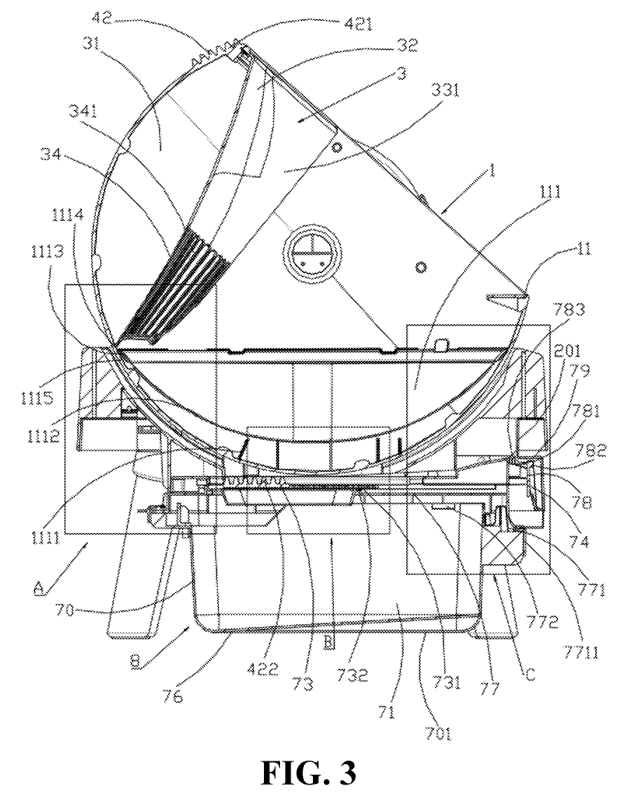

FIG. 4 is an enlarged view of area A in FIG. 3;

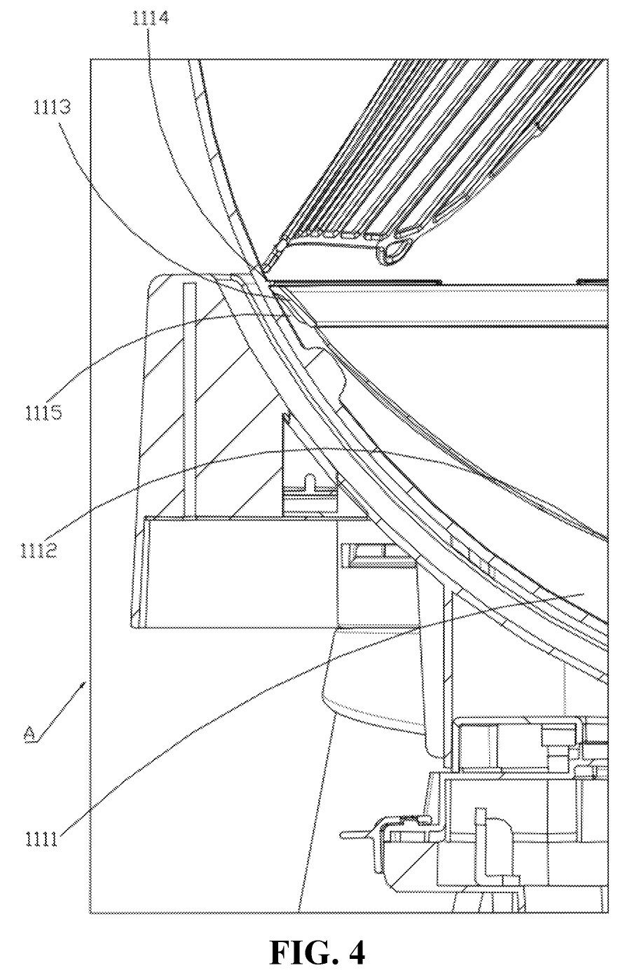

FIG. 5 is an enlarged view of area B in FIG. 3;

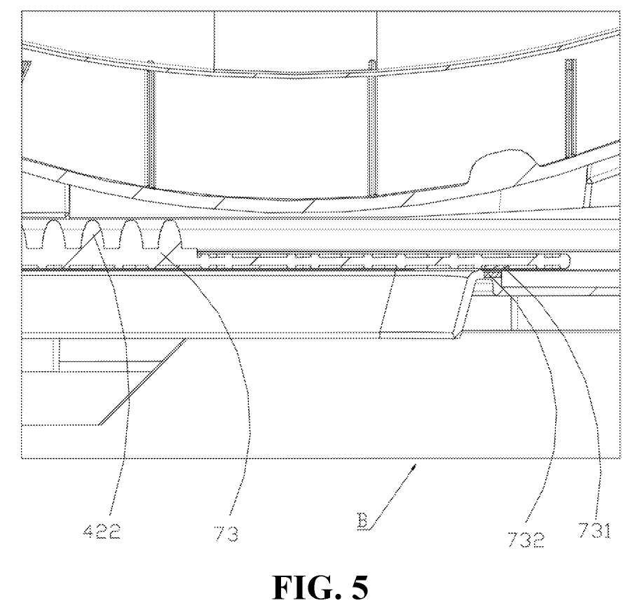

FIG. 6 is an enlarged view of area C in FIG. 3;

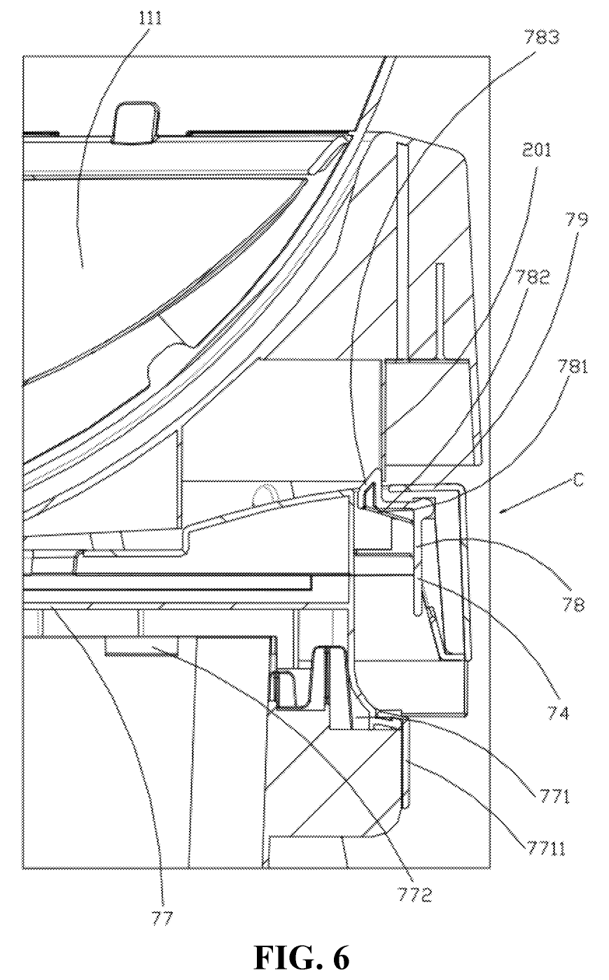

FIG. 7 is a sectional view taken along the roller when the roller is in the discharge position;

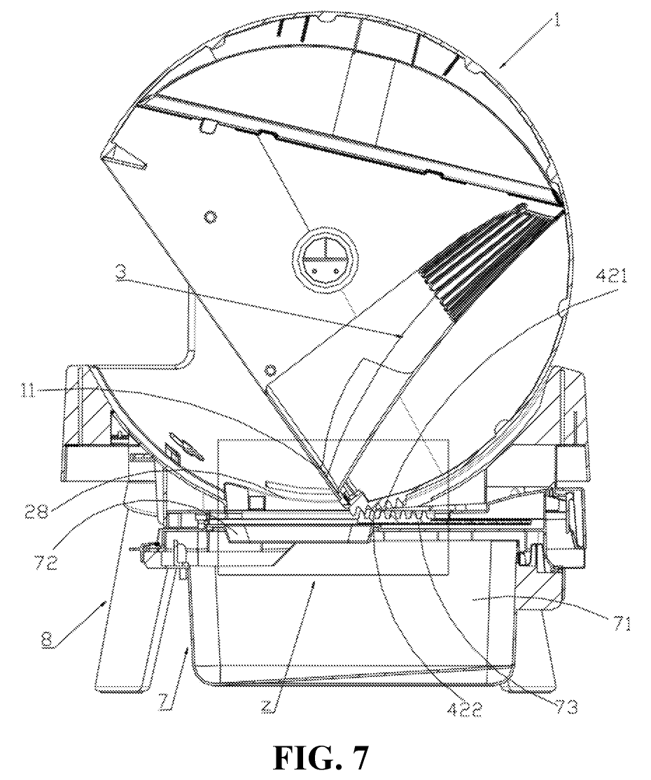

FIG. 8 is an enlarged view of area Z in FIG. 7;

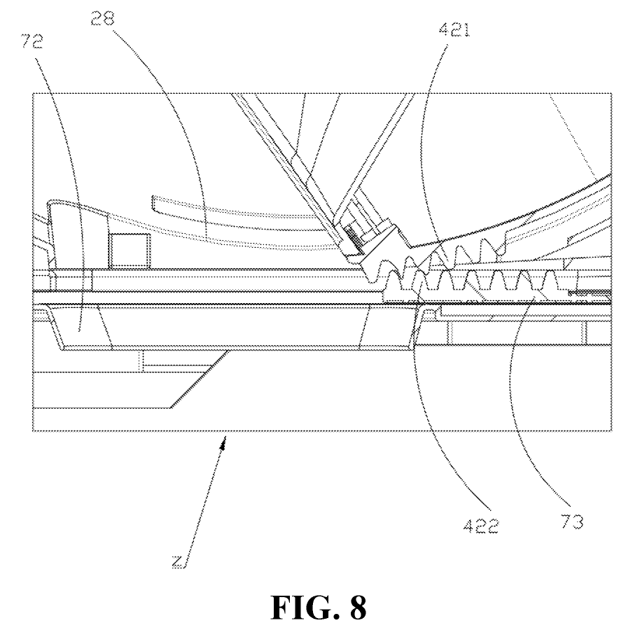

FIG. 9 is a sectional view taken along a main body, a first supporting portion, and a second supporting portion, when the roller is in the initial position;

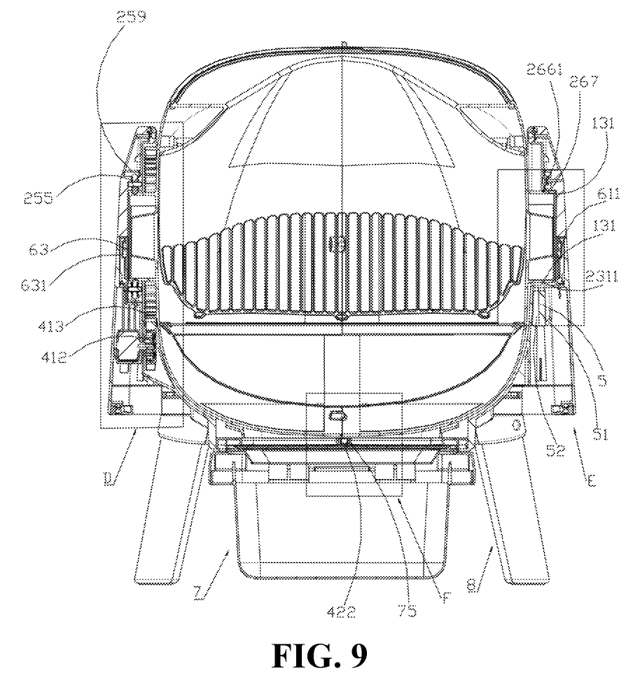

FIG. 10 is an enlarged view of area D in FIG. 9;

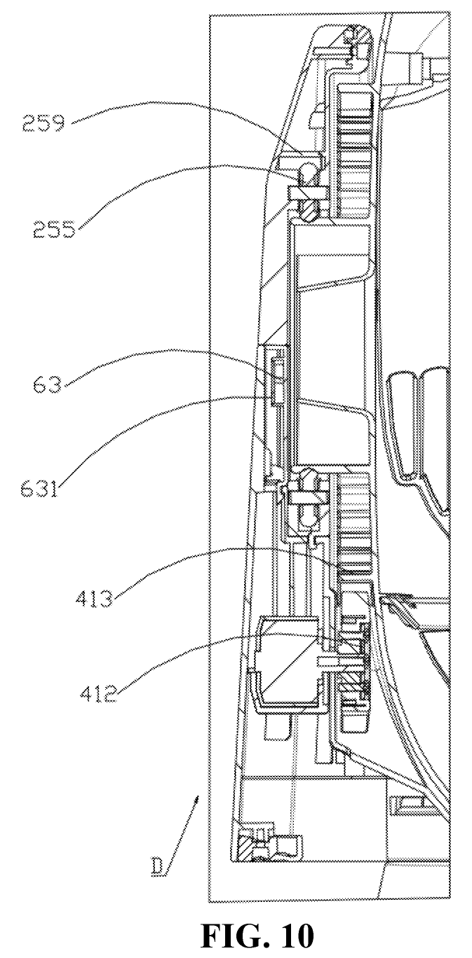

FIG. 11 is an enlarged view of area F in FIG. 9;

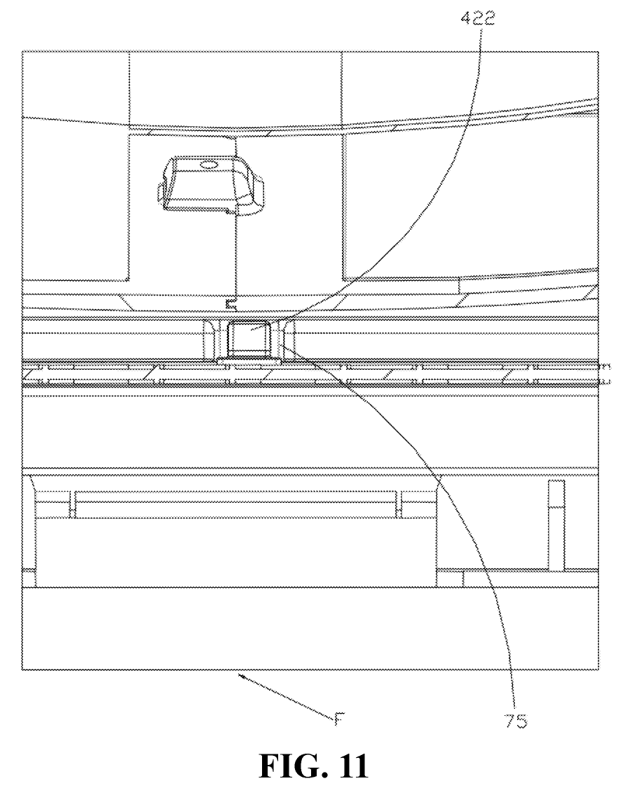

FIG. 12 is an enlarged view of area E in FIG. 9;

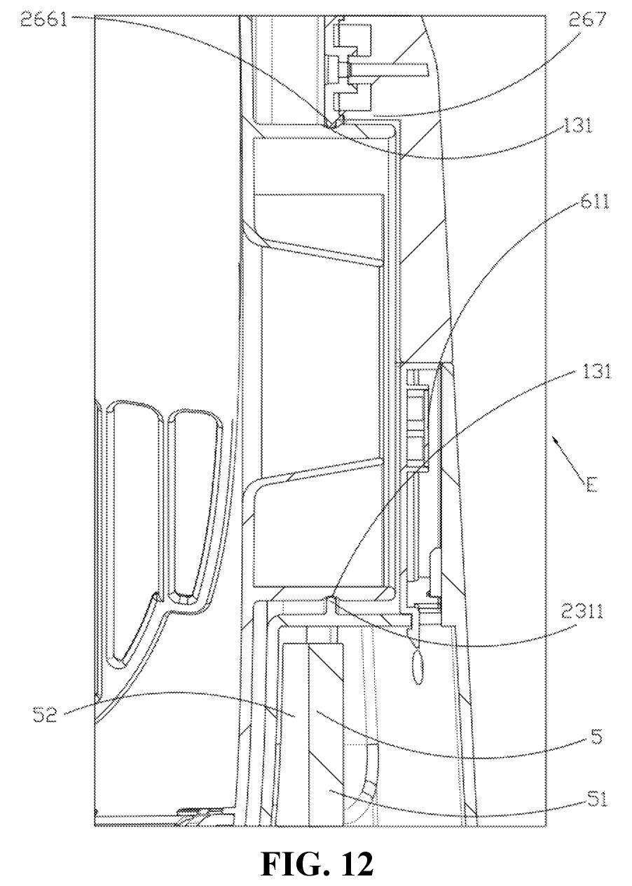

FIG. 13 is a schematic structural view of the roller and a drive assembly;

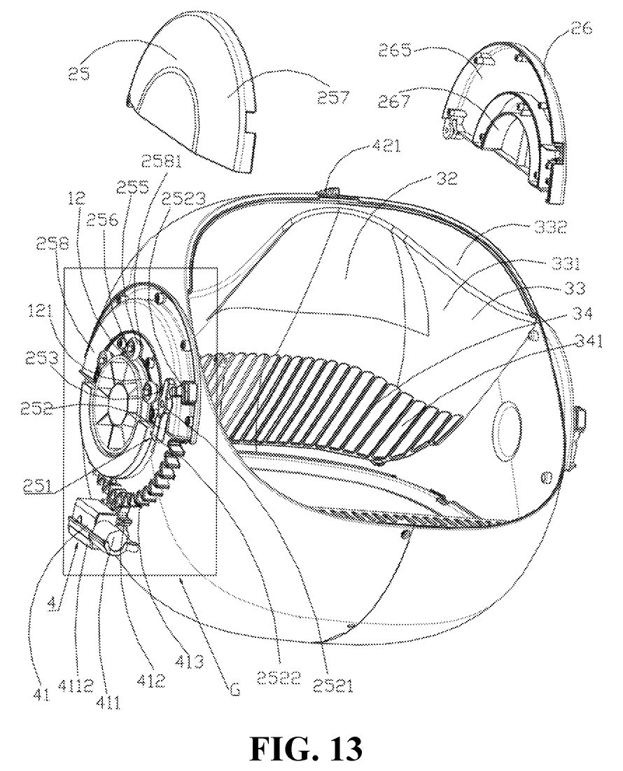

FIG. 14 is an enlarged view of area G in FIG. 13;

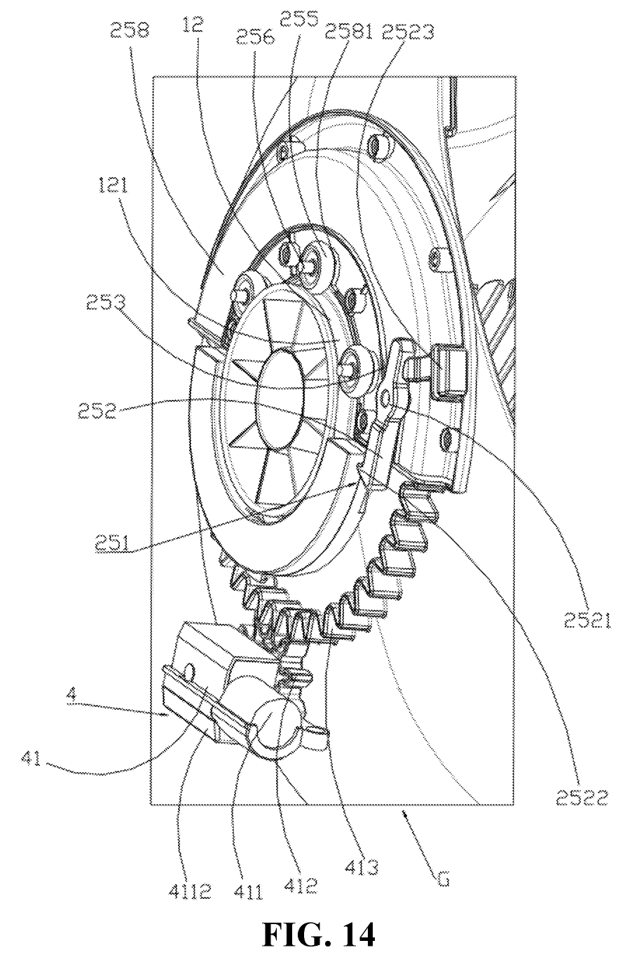

FIG. 15 is a schematic structural view of the roller and a flip cover;

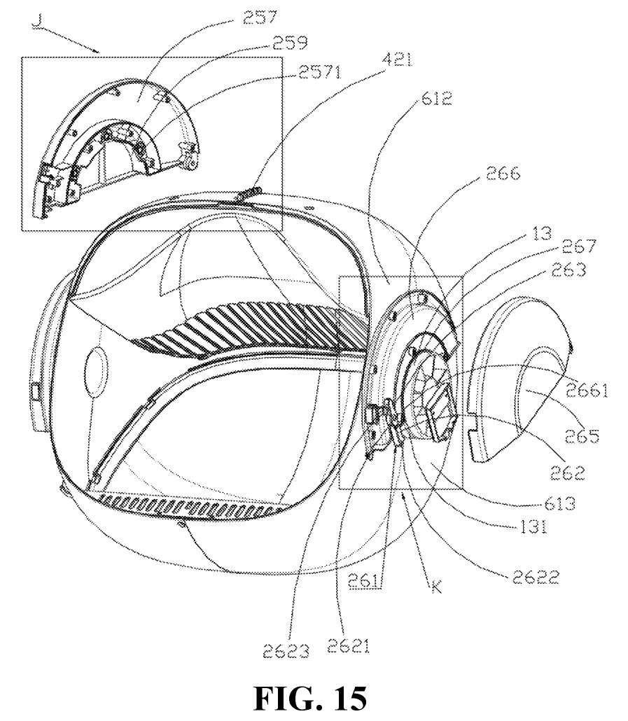

FIG. 16 is an enlarged view of area J in FIG. 15;

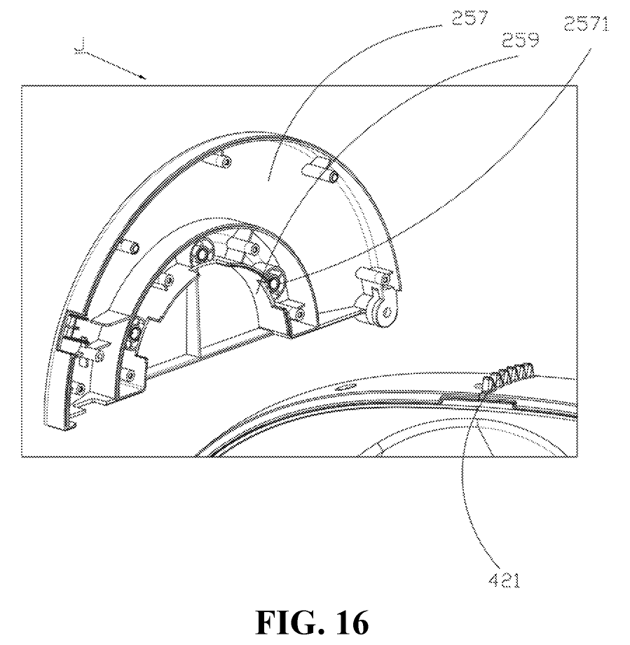

FIG. 17 is an enlarged view of area K in FIG. 15;

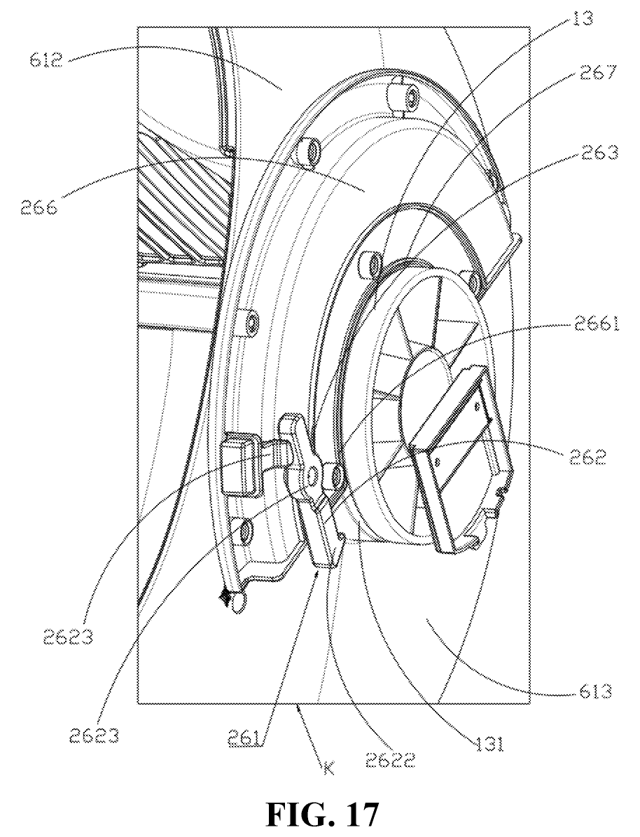

FIG. 18 is a schematic structural view of a base;

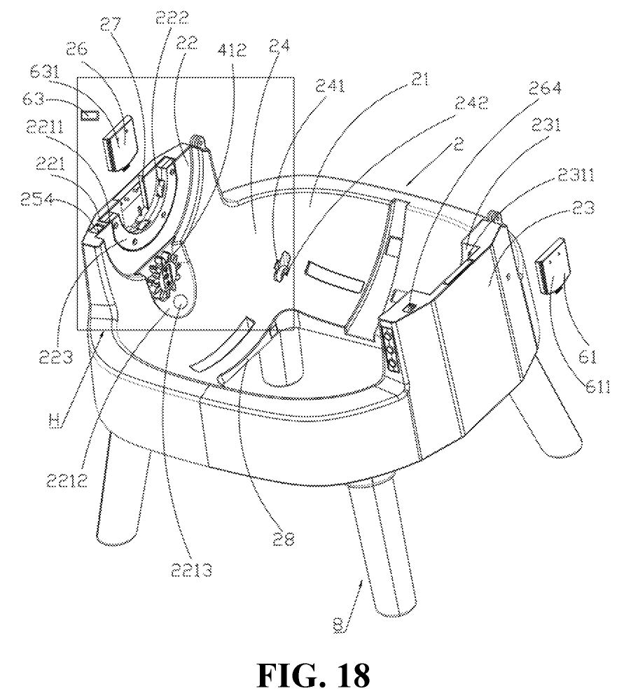

FIG. 19 is an enlarged view of area H in FIG. 18;

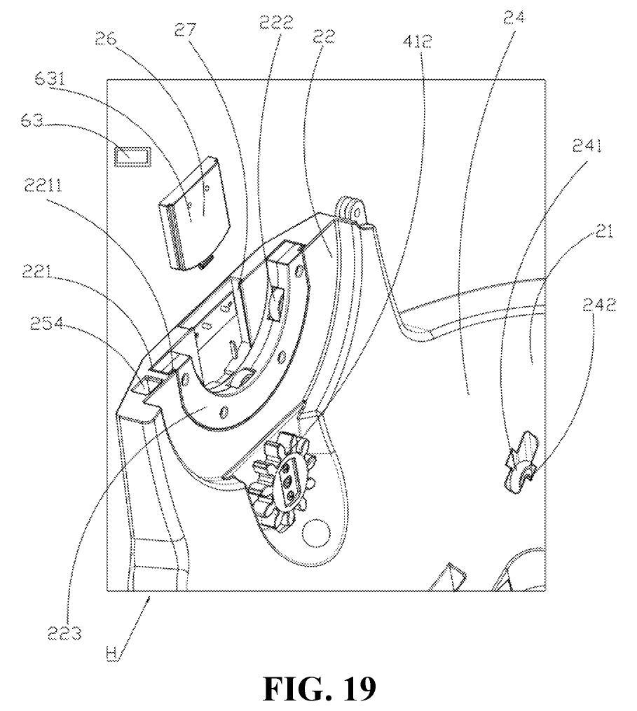

FIG. 20 is an exploded view of the base and support feet;

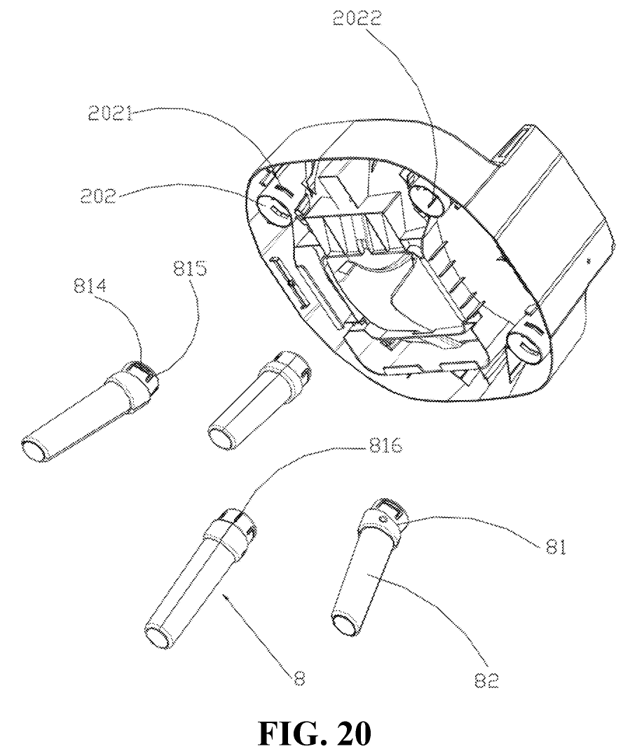

FIG. 21 is an exploded view of the base, the support feet, a sealing plate, and a chassis;

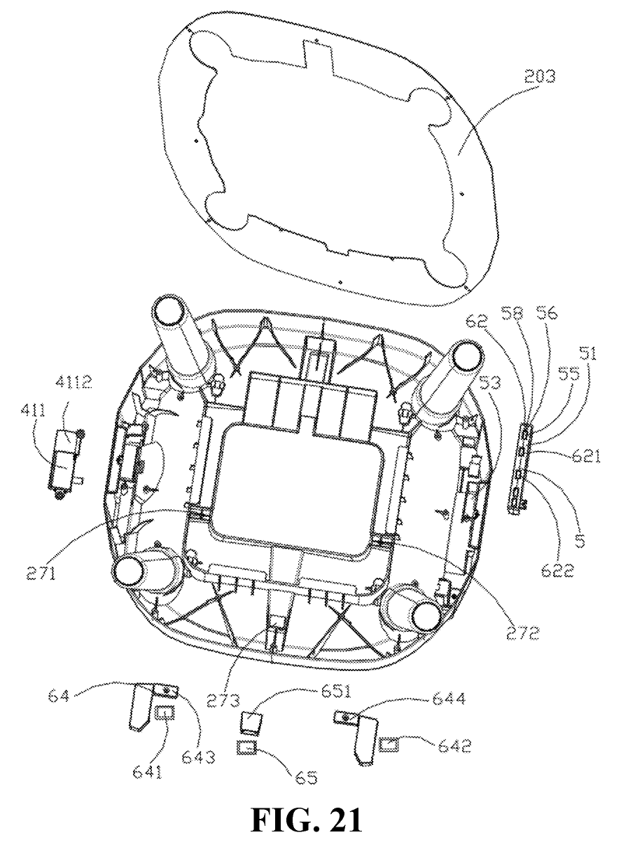

FIG. 22 is an exploded view of the support foot;

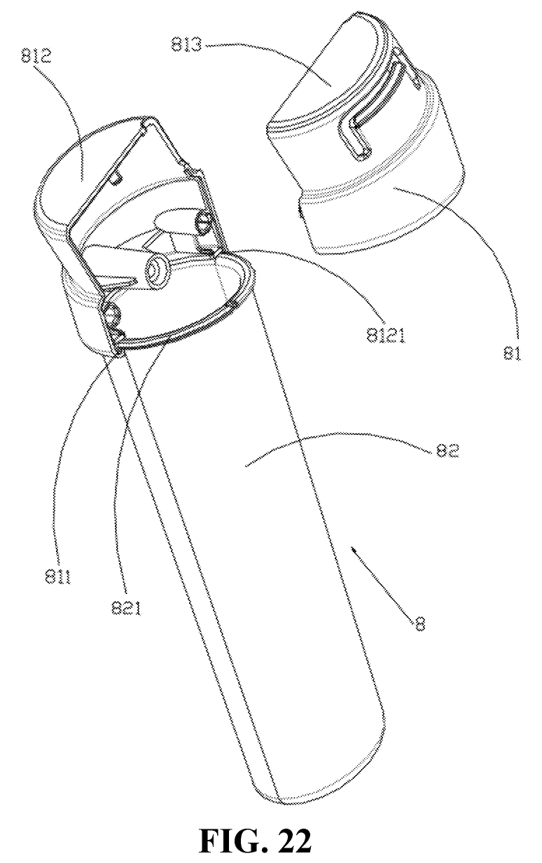

FIG. 23 is another exploded view of the support foot;

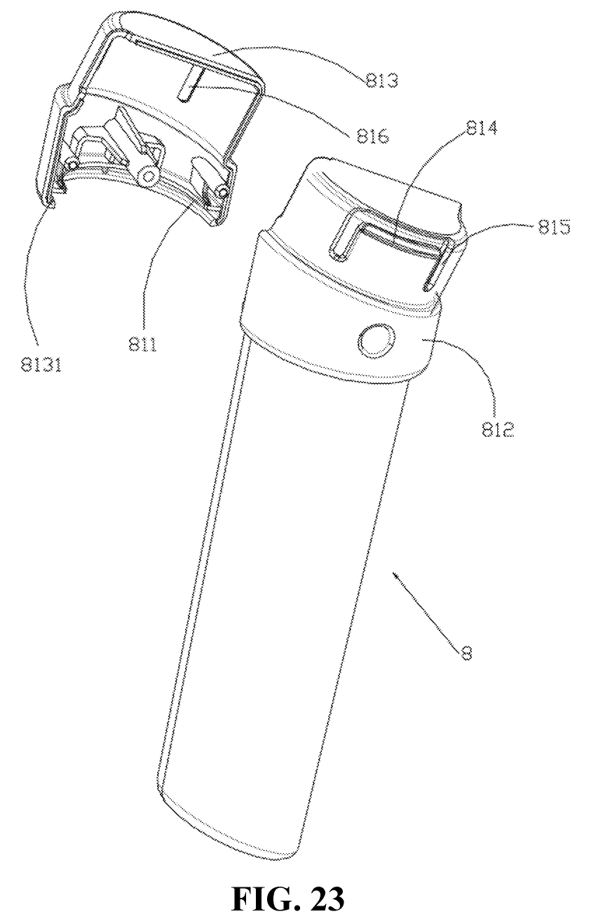

FIG. 24 is a schematic structural view of a waste collection box;

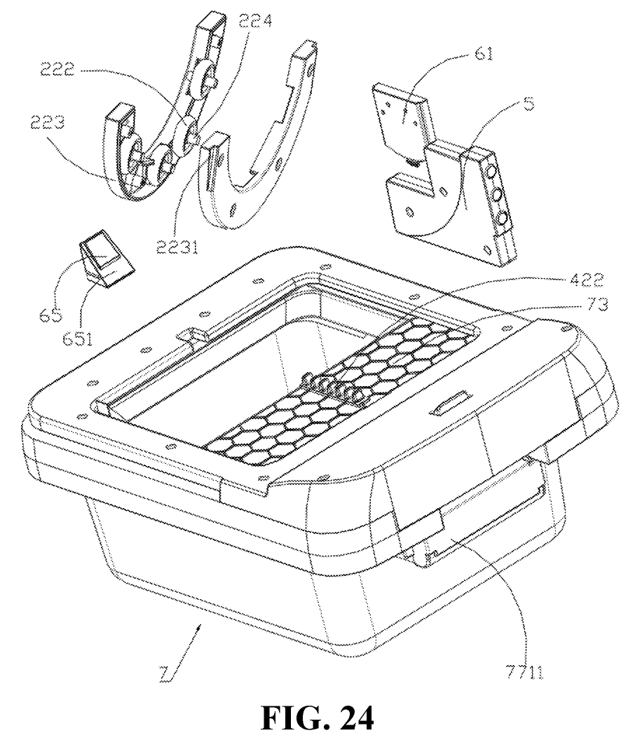

FIG. 25 is an exploded view of the waste collection box;

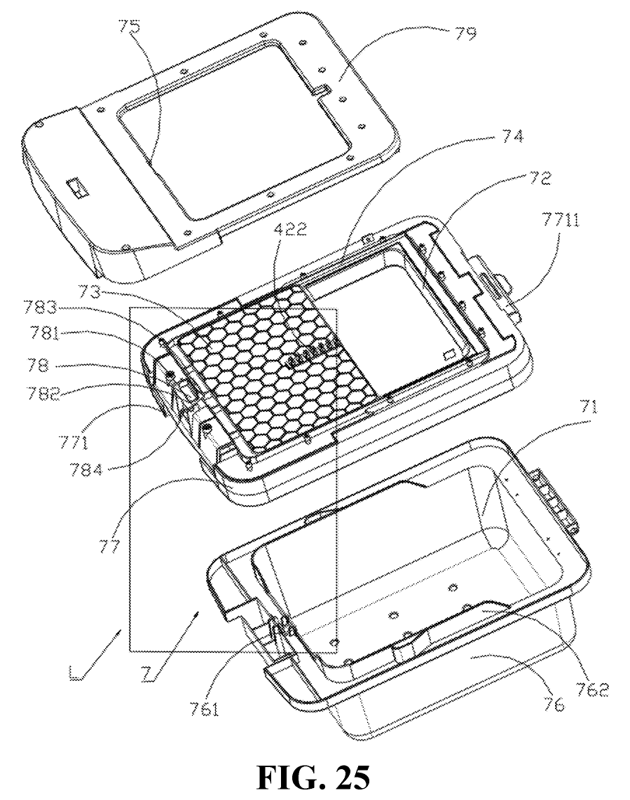

FIG. 26 is an enlarged view of area L in FIG. 25;

FIG. 27 is a schematic structural view of an elastic reset device;

FIG. 28 is an enlarged view of area A in FIG. 27;

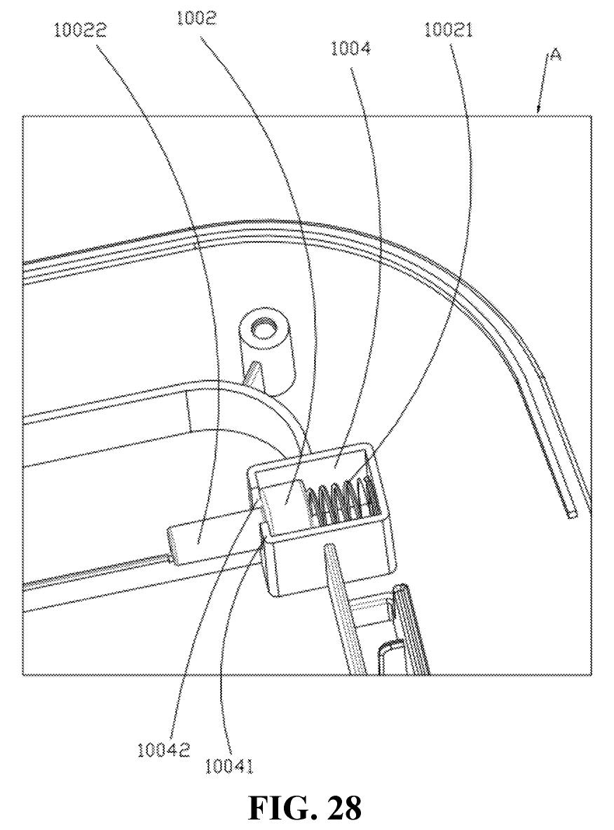

FIG. 29 is an enlarged view of area B in FIG. 27;

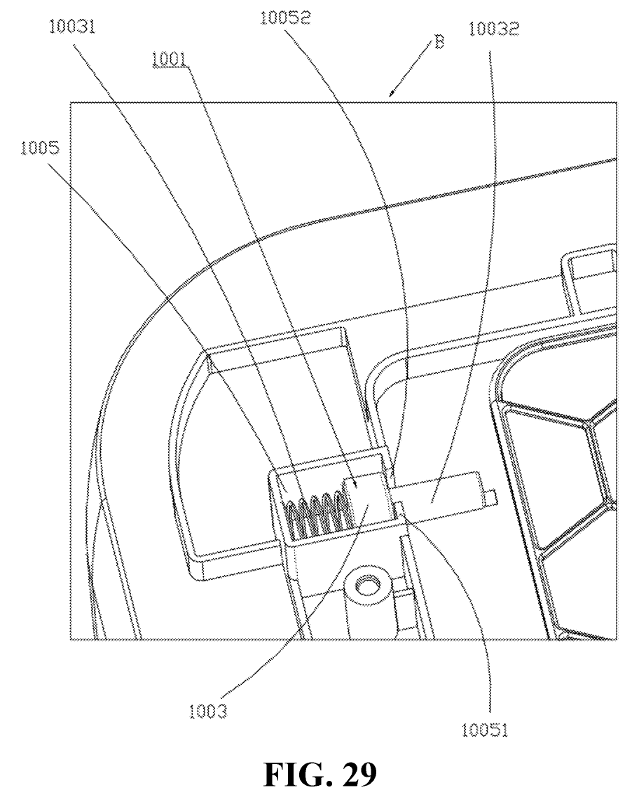

FIG. 30 is an exploded view of the elastic reset device;

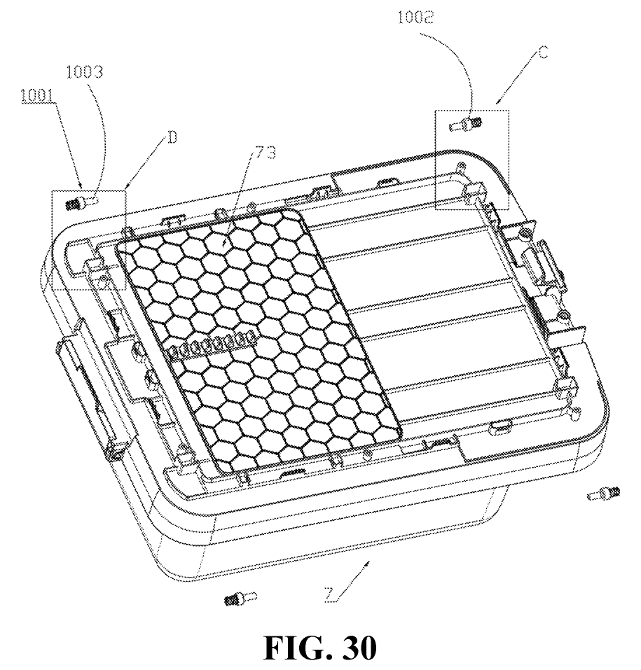

FIG. 31 is an enlarged view of area C in FIG. 30;

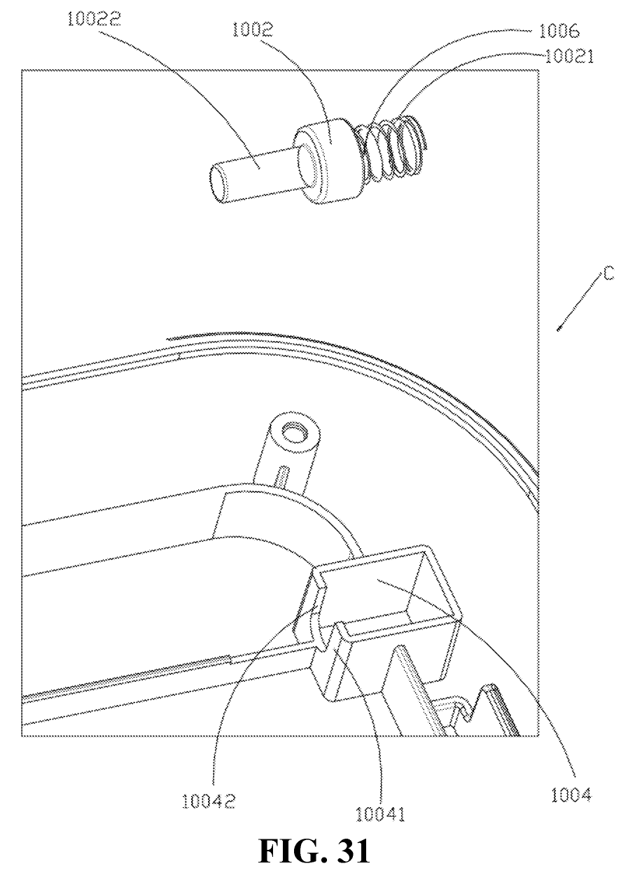

FIG. 32 is an enlarged view of area D in FIG. 30;

FIG. 33 is a schematic structural view of the waste collection box mounted on the base of the present disclosure;

FIG. 34 is an exploded view of the base, the roller, the waste collection box, and the sealing plate of the present disclosure;

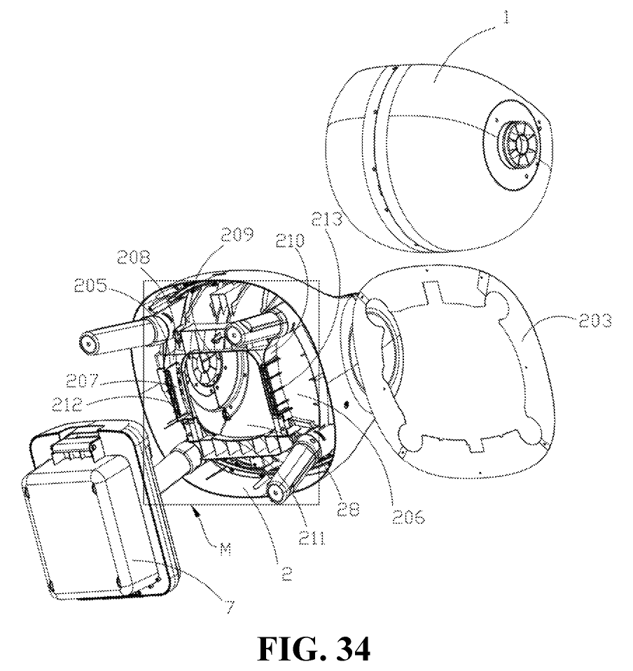

FIG. 35 is an enlarged view of area M in FIG. 34;

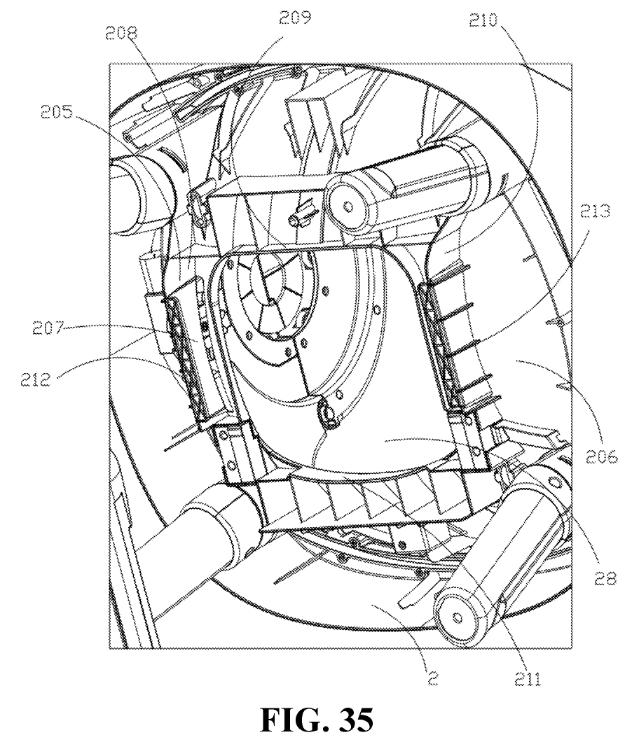

FIG. 36 is a schematic view showing that the waste collection box is separated from the base of the present disclosure;

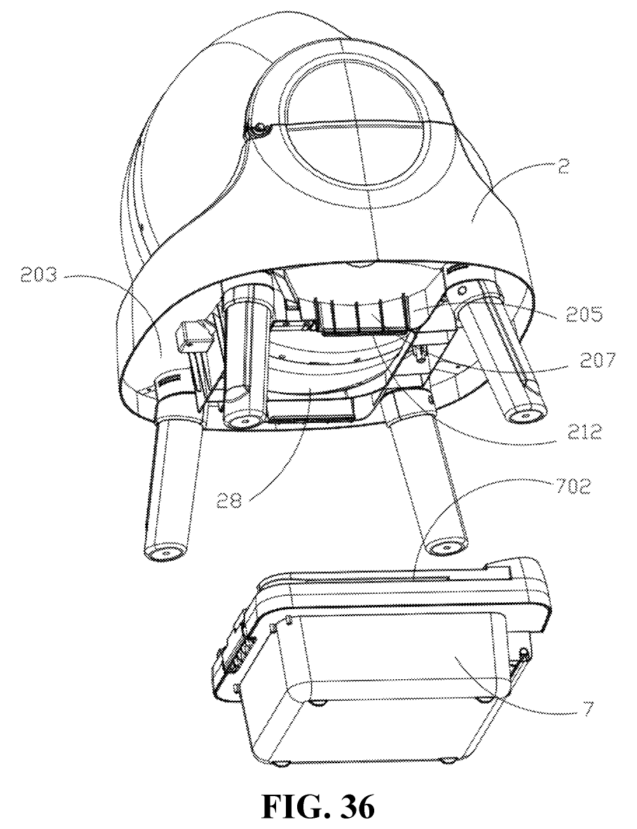

FIG. 37 is an exploded view of the roller, the base, and the waste collection box of the present disclosure;

FIG. 38 is an exploded view of the roller, the base, the waste collection box, and a sliding rail structure of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

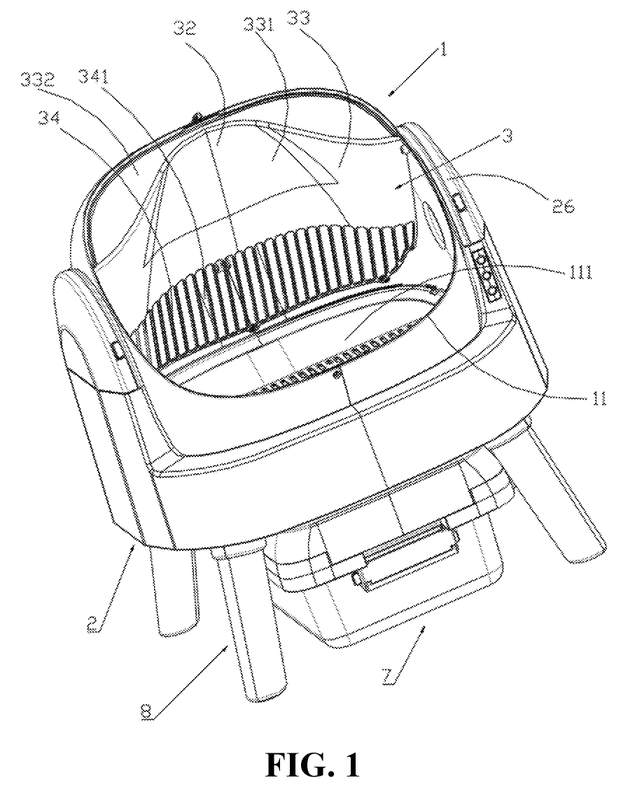

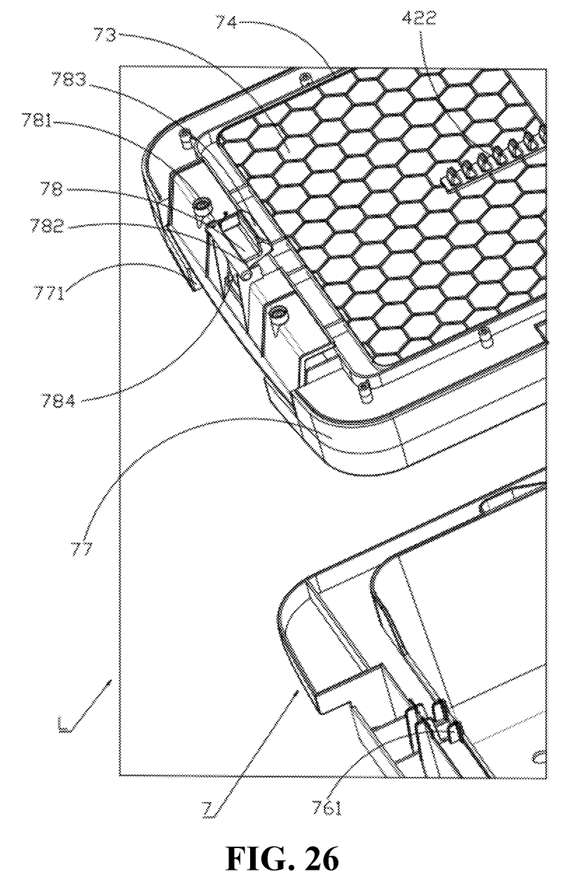

Referring to FIG. 1 - FIG. 26, a pet toilet includes a roller 1, a base 2, a sifting assembly 3 and a driving device 4.

The roller 1 is provided with a first opening 11 and a first accommodating space 111. The first opening 11 is in communication with the first accommodating space 111. The first accommodating space 111 is configured for accommodating pet excreta and pet litter.

The roller 1 is supported on the base 2. The base 2 includes a main body 21, a first supporting portion 22, and a second supporting portion 23. The first supporting portion 22 is connected to a first side of the main body 21, and the second supporting portion 23 is connected to a second side of the main body 21. The first supporting portion 22 is configured for supporting the first side of the roller 1, and the first supporting portion 22 is integrally formed with the main body 21. The second supporting portion 23 is configured for supporting the second side of the roller 1, and the second supporting portion 23 is integrally formed with the main body 21.

The sifting assembly 3 is connected to the roller 1. The sifting assembly 3 and an inner wall of the roller 1 together surround to form a second accommodating space 31. The second accommodating space 31 is adjacent to the first accommodating space 111. The sifting assembly 3 is configured for separating the pet litter from the excreta.

The driving device 4 is configured for driving the roller 1 to rotate on the first supporting portion 22 and the second supporting portion 23. When the first opening 11 rotates along with the roller 1 from an initial position to a discharge position, the pet litter can enter the second accommodating space 31 through the sifting assembly 3, and the excreta is limited outside the second accommodating space 31, thereby allowing the excreta to be discharged through the first opening 11 under its own gravity. When the first opening 11 rotates from the discharge position to the initial position along with the roller 1, the pet litter in the second accommodating space 31 can pass through the sifting assembly 3 and fall back into the first accommodating space 111 under its own gravity.

Through the above structure, when the roller 1 rotates from the initial position to the discharge position, the pet litter can enter the second accommodating space 31 through the sifting assembly 3, and the excreta is limited outside the second accommodating space 31, so as to achieve the sieving of the pet litter and the pet excreta. The excreta is discharged through the first opening 11 under its own gravity, completing separation and collection of the excreta. After the excreta is discharged, when the roller 1 rotates from the discharge position to the initial position, the pet litter in the second accommodating space 31 can pass through the sifting assembly 3 and fall back into the first accommodating space 111 under its own gravity. Moreover, since the roller 1 is supported by the first supporting portion 22 and the second supporting portion 23, the roller 1 is capable of rotating more smoothly. Moreover, the first supporting portion 22 and the second supporting portion 23 are integrated with the main body 21. This greatly improves stability of the base 2, enhances strength of the base 2, facilitates production, and reduces installation steps, thereby greatly improving production efficiency and reducing production costs.

In the present embodiment, the first supporting portion 22 is provided with a first supporting groove 221. The second supporting portion 23 is provided with a second supporting groove 231. The first side of the roller 1 is provided with a first supporting shaft 12, and the second side of the roller 1 is provided with a second supporting shaft 13. The first supporting shaft 12 is positioned in the first supporting groove 221, and the first supporting shaft 12 is rotatable in the first supporting groove 221. The second supporting shaft 13 is positioned in the second supporting groove 231, and the second supporting shaft 13 is rotatable in the second supporting groove 231. The first supporting groove 221 is provided with a plurality of second rotating wheels 222. The second rotating wheels 222 are supported by the first supporting shaft 12. Through the above structure, when the first supporting shaft 12 rotates in the first supporting groove 221, the first supporting shaft 12 supports the second rotating wheels 222, so that the roller 1 rotates on the first supporting portion 22 of the base 2 via the first supporting shaft 12, thereby effectively improving transmission efficiency. Moreover, a weight of the roller 1 is concentrated on the supporting portions on both sides of the main body 21, which can prevent the weight of the roller 1 from concentrating on the main body 21 and prevent deformation and damage of the main body 21.

In the present embodiment, a wheel frame 223 is arranged inside the first supporting groove 221, and the second rotating wheels 222 are rotatably arranged on the wheel frame 223. The second rotating wheels 222 are rotatably connected to the wheel frame 223 through a first rotating shaft 224. Specifically, the wheel frame 223 is arc-shaped. A lower surface of the wheel frame 223 abuts against the first supporting groove 221, and the plurality of second rotating wheels 222 are arranged uniformly along an upper surface of the wheel frame 223. Furthermore, the lower surface of the wheel frame 223 is provided with a first positioning groove 2231. The first supporting groove 221 is internally provided with a first positioning protrusion 2211. The first positioning groove 2231 is engaged with the first positioning protrusion 2211. Furthermore, a first annular groove 121 is defined in the first supporting shaft 12, and the second rotating wheels 222 are rotatable in the first annular groove 121. Furthermore, a second annular groove 131 is defined in the second supporting shaft 13, and a first annular protrusion 2311 is arranged in the second supporting groove 231. The first annular protrusion 2311 is rotatably connected to the second annular groove 131. Through the above structure, the arrangement of the second rotating wheels 222 is effectively achieved, and the second rotating wheels 222 can be easily replaced, disassembled, and cleaned through the wheel frame 223. Moreover, since the second rotating wheels 222 rotate in the first annular groove 121, the position of the second rotating wheels 222 can be prevented from shifting, improving operation stability of the second rotating wheels 222, so as to enable the first supporting shaft 12 to rotate stably in the first supporting groove 221. Furthermore, the first annular protrusion 2311 is rotatably connected to the second annular groove 131 to enable the second supporting shaft 13 to rotate stably in the second supporting groove 231.

In the present embodiment, the main body 21 of the base 2 is further provided with a recessed portion 24 recessed in a direction away from the roller 1. A third rolling wheel 241 is arranged in the recessed portion 24. When the roller 1 is supported on the base 2, the third rolling wheel 241 is supported on an outer side wall of the roller 1. The third rolling wheel 241 inside the recessed portion 24 can facilitate rotation of the roller 1, allowing the roller 1 to rotate more smoothly on the supporting portions of the base 2. The third rolling wheel 241 is rotatably connected to the main body 21 through a second rotating shaft 242.

In the present embodiment, the pet toilet further includes a first flip cover 25 and a second flip cover 26. A first end of the first flip cover 25 is rotatably connected to a first side of the first supporting portion 22, and a second end of the first flip cover 25 is detachably connected to a second side of the first supporting portion 22. The first flip cover 25 covers the first supporting groove 221 to retain the first supporting shaft 12 in the first supporting groove 221. A first end of the second flip cover 26 is rotatably connected to a first side of the second supporting portion 23, and a second end of the second flip cover 26 is detachably connected to a second side of the second supporting portion 23. The second flip cover 26 covers the second supporting groove 231 to retain the second supporting shaft 13 in the second supporting groove 231. Through the above structure, the first flip cover 25 covers the first supporting groove 221 to retain the first supporting shaft 12 in the first supporting groove 221, and the second flip cover 26 covers the second supporting groove 231 to retain the second supporting shaft 13 in the second supporting groove 231, so as to prevent the first supporting shaft 12 from detaching from the first supporting groove 221 during rotation and to prevent the second supporting shaft 13 from detaching from the second supporting groove 231 during rotation, thereby enabling the roller 1 to rotate more smoothly on the base 2. Moreover, since the first end of the first flip cover 25 is rotatably connected to the first side of the first supporting portion 22, the second end of the first flip cover 25 is detachably connected to the second side of the first supporting portion 22, the first end of the second flip cover 26 is rotatably connected to the first side of the second supporting portion 23, and the second end of the second flip cover 26 is detachably connected to the second side of the second supporting portion 23, it is convenient for a user to open or close the first flip cover 25 and the second flip cover 26, thereby facilitating the user to install or remove the roller 1 from the first supporting portion 22 or the second supporting portion 23.

In the present embodiment, the pet toilet further includes a first locking member 251 and a second locking member 261. The first flip cover 25 is detachably connected to the first supporting portion 22 through the first locking member 251, and the second flip cover 26 is detachably connected to the second supporting portion 23 through the second locking member 261. The first locking member 251 includes a first locking catch 252, a first elastic member 253, and a first locking hole 254 provided on the first supporting portion 22. The first locking catch 252 includes a first connecting end 2521, a first locking hook end 2522, and a first pushing end 2523. The first connecting end 2521 is arranged between the first locking hook end 2522 and the first pushing end 2523. The first connecting end 2521 is rotatably connected to the first flip cover 25. The first elastic member 253 is connected to the first locking catch 252, so as to push and lock the first locking hook end 2522 of the first locking catch 252 to the first locking hole 254. Under an action of external force, the first pushing end 2523 is capable of pushing the first locking hook end 2522 to rotate and detach from the first locking hole 254. The second locking member 261 includes a second locking catch 262, a second elastic member 263, and a second locking hole 264 provided on the second supporting portion 23. The second locking catch 262 includes a second connecting end 2621, a second locking hook end 2622, and a second pushing end 2623. The second connecting end 2621 is arranged between the second locking hook end 2622 and the second pushing end 2623. The second connecting end 2621 is rotatably connected to the second flip cover 26. The second elastic member 263 is connected to the second locking catch 262, so as to push and lock the second locking hook end 2622 of the second locking catch 262 to the second locking hole 264. Under the action of external force, the second pushing end 2623 is capable of pushing the second locking hook end 2622 to rotate and detach from the second locking hole 264. Through the above structure, the detachable connection between the first flip cover 25 and the first supporting portion 22 is effectively achieved. Moreover, the detachable connection between the second flip cover 26 and the second supporting portion 23 is also effectively achieved. Therefore, by pushing the first pushing end 2523 to push the first locking hook end 2522 to rotate and detach from the first locking hole 254, and by pushing the second pushing end 2623 to push the second locking hook end 2622 to rotate and detach from the second locking hole 264, the flip covers can be opened, thereby facilitating the user to install and remove the roller 1.

In the present embodiment, the pet toilet further includes a first rolling wheel 255 and a third rotating shaft 256. The first flip cover 25 includes a first housing unit 257 and a second housing unit 258. The first housing unit 257 is detachably connected to the second housing unit 258. The first housing unit 257 is provided with a first mounting shaft hole 2571. The second housing unit 258 is provided with a second mounting shaft hole 2581. The first rolling wheel 255 is rotatably sleeved on the first rotating shaft 224. A first end of the third rotating shaft 256 is inserted into the first mounting shaft hole 2571, and a second end of the third rotating shaft 256 is inserted into the second mounting shaft hole 2581. The first rolling wheel 255 abuts against the first supporting shaft 12 and is rotatable in the first annular groove 121. The second flip cover 26 includes a third housing unit 265 and a fourth housing unit 266. The third housing unit 265 is detachably connected to the fourth housing unit 266. A second annular protrusion 2661 is arranged on the third housing unit 265 or the fourth housing unit 266. The second annular protrusion 2661 is rotatably connected to the second annular groove 131. Through the above structure, the first rolling wheel 255 is capable of reducing a friction force between the first supporting shaft 12 and the flip cover, making rotation of the first supporting shaft 12 smoother, so that the roller 1 can rotate more smoothly.

In the present embodiment, the first flip cover 25 is further provided with a first retaining groove 259. The second flip cover 26 is further provided with a second retaining groove 267. The first retaining groove 259 covers an upper half of the first supporting shaft 12, and the first supporting groove 221 supports a lower half of the first supporting shaft 12. The second retaining groove 267 covers an upper half of the second supporting shaft 13, and the second supporting groove 231 supports a lower half of the second supporting shaft 13. The first rolling wheel 255 is positioned inside the first retaining groove 259, and the second annular protrusion 2661 is positioned inside the second retaining groove 267. Through the above structure, the first flip cover 25 and the first supporting groove 221 completely cover the first supporting shaft 12, while the second flip cover 26 and the second supporting groove 231 completely cover the second supporting shaft 13, so as to prevent positional displacement of the first supporting shaft 12 and the second supporting shaft 13 during rotation. Moreover, since the first rolling wheel 255 is arranged in the first retaining groove 259, the first rolling wheel 255 is exposed and can abut against and roll in the first annular groove 121, so as to provide effective rolling support for the first supporting shaft 12, thereby reducing frictional resistance.

In the present embodiment, the pet toilet further includes a chassis 5 and a main control board 51. The main control board 51 is electrically connected to the driving device 4. The chassis 5 is provided with a fifth accommodating space 52, and the fifth accommodating space 52 is formed by side walls of the chassis 5. The main control board 51 is arranged inside the chassis 5. The base 2 is provided with a chassis insertion slot 53, and the chassis 5 is inserted into the chassis insertion slot 53. Through the above structure, the main control board 51 is arranged inside the chassis 5, and the chassis 5 is inserted into the chassis insertion slot 53, thereby effectively realizing modular disassembly and assembly of the main control board 51, making it convenient for the user to install, disassemble, replace, and repair the main control board 51.

In the present embodiment, the chassis 5 is connected to the base 2 through a first connecting member. The first connecting member is a first screw. By fixing the chassis 5 in the chassis insertion slot 53 via the first connecting member, the chassis 5 is prevented from loosening out of the chassis insertion slot 53.

In the present embodiment, the pet toilet further includes an interface group 55. The interface group 55 includes a plurality of interfaces. The interface group 55 is electrically connected to the main control board 51. The chassis 5 is provided with a plurality of first mounting openings 56. The interface group 55 is electrically connected to the main control board 51. The interface group 55 is positioned inside the first mounting opening 56, and a sealing member 58 is arranged between the interface group 55 and an inner wall of the first mounting opening 56. The pet toilet further includes a first infrared detection device 6. The first infrared detection device 6 is electrically connected to the main control board 51 via the interface group 55. The first infrared detection device 6 is connected to the roller 1 or base 2. The first infrared detection device 6 is configured for detecting whether a pet has entered the roller 1. Specifically, the pet toilet further includes a Hall sensing device 61. The Hall sensing device 61 is electrically connected to the main control board 51 via the interface group 55. The Hall sensing device 61 is configured for detecting a position of the rotation of the roller 1. Furthermore, the Hall sensing device 61 includes a magnetic sensing region 611, a first magnetic pole 612, and a second magnetic pole 613. The magnetic sensing region 611 is arranged at the base 2. The first magnetic pole 612 and the second magnetic pole 613 are located at the roller 1. When the roller 1 rotates to the initial position, the first magnetic pole 612 is positioned in the magnetic sensing region 611. When the roller 1 rotates to the discharge position, the second magnetic pole 613 is positioned in the magnetic sensing region 611. Furthermore, the interface group 55 includes at least a first infrared detection device interface 62, a Hall sensing device interface 621, and a power supply interface 622. The first infrared detection device interface 62 is electrically connected to the first infrared detection device 6. The Hall sensing device interface 621 is electrically connected to the Hall sensing device 61. The power supply interface 622 is configured for supplying power to the driving device 4.

Through the above structure, the first infrared detection device 6 is capable of detecting whether a pet has entered the roller 1. When the pet is detected to enter the toilet and leave the roller 1, the main control board 51 is capable of controlling the roller 1 to rotate from the initial position to the discharge position based on a signal from the first infrared detection device 6. When the magnetic sensing region 611 senses the second magnetic pole 613, the roller 1 rotates to the discharge position, and the main control board 51 controls the roller 1 to stop rotating based on a signal fed back from the Hall sensing device 61, so as to discharge excreta into a waste collection box 7. After the excreta is discharged through the first opening 11, the main control board 51 controls the roller 1 to rotate from the discharge position to the initial position. When the magnetic sensing region 611 senses the first magnetic pole 612, the roller 1 rotates to the initial position, and the main control board 51 controls the roller 1 to stop rotating based on the signal fed back from the Hall sensing device 61, so that the roller 1 remains in the initial position for the pet to enter and exit the toilet. Furthermore, since the main control board 51 is arranged inside the chassis 5, and the chassis 5 is provided with the first infrared detection device interface 62, the Hall sensing device interface 621 and the power supply interface 622, a modular design is achieved to facilitate installation of the main control board 51 with the first infrared detection device 6, the Hall sensing device 61, and the driving device 4. Moreover, due to the sealing member 58 arranged between the interface group 55 and the inner wall of the first mounting opening 56, liquid is prevented from seeping into the chassis 5, so that the main control board 51 inside the chassis 5 is prevented from being corroded by the liquid, and short circuit of the main control board 51 caused by the liquid seeping into the chassis 5 can be prevented, thereby further improving the service life of the pet toilet. The chassis 5 is further provided with a plurality of control buttons. The control buttons are electrically connected to the main control board 51 and the driving device 4, so as to control the rotation of the roller 1. Through the above structure, the user can also manually control the rotation of the roller 1 via the control buttons.

In the present embodiment, the first infrared detection device 6 includes a first infrared detection module 63 and a first mounting box 631. The first infrared detection module 63 is arranged inside the first mounting box 631, and the base 2 is provided with a first insertion slot 27. The first mounting box 631 is inserted into the first insertion slot 27, and the first mounting box 631 is connected to the base 2 via a second connecting member. The second connecting member is a second screw. Through the above structure, the modular design of the first infrared detection device 6 is achieved, thereby facilitating the installation of the first infrared detection device 6 by the user.

In the present embodiment, a second opening 28 is also provided on the base 2. When the first opening 11 rotates along with the roller 1 from the initial position to the discharge position, the pet litter can enter the second accommodating space 31 through the sifting assembly 3, the excreta is limited outside the second accommodating space 31, and the first opening 11 rotates along with the roller 1 to align with the second opening 28, so that the excreta can be discharged through the first opening 11 and the second opening 28 under its own gravity. When the first opening 11 rotates along with the roller 1 from the discharge position to the initial position, the first opening 11 is misaligned with the second opening 28, and the pet litter in the second accommodating space 31 can pass through the sifting assembly 3 and fall back into the first accommodating space 111 under its own gravity. The pet toilet further includes a second infrared detection device 64. The second infrared detection device 64 is connected to the base 2, and the second infrared detection device 64 is electrically connected to the main control board 51. The second infrared detection device 64 includes a first infrared emitting module 641 and a first infrared receiving module 642. The first infrared emitting module 641 and the first infrared receiving module 642 are respectively arranged on both sides of the second opening 28. When the roller 1 rotates to the discharge position, the second infrared detection device 64 is configured for detecting whether a pet has entered the second opening 28. Through the above structure, when the second infrared detection device 64 detects that the pet is at the second opening 28, the roller 1 stops rotating, so that the pet is prevented from being pinched by the roller 1 and the base 2.

Specifically, the pet toilet further includes a third infrared detection device 65. The third infrared detection device 65 is a third infrared distance detection device. The third infrared detection device 65 is connected to the base 2, and the third infrared detection device 65 is electrically connected to the main control board 51. An emitting end of the third infrared detection device 65 is arranged facing above the second opening 28. When the roller 1 rotates to the discharge position, the third infrared detection device 65 is configured for detecting whether there is a pet above the second opening 28. Through the above structure, when the third infrared detection device 65 detects that the pet is above the second opening 28, the roller 1 stops rotating to prevent the roller 1 and the base 2 from pinching the pet.

Furthermore, the second infrared detection device 64 and the third infrared detection device 65 start detection when the roller 1 rotates to the discharge position. When the roller 1 rotates to block the second infrared detection device 64, the second infrared detection device 64 stops operation. When the roller 1 rotates to block the third infrared detection device 65, the third infrared detection device 65 stops operation, so as to prevent false detection by the second infrared detection device 64 and the third infrared detection device 65.

Furthermore, the pet toilet further includes a second mounting box 643, a third mounting box 644, and a fourth mounting box 651. The first infrared emitting module 641 is arranged inside the second mounting box 643. The first infrared receiving module 642 is arranged inside the third mounting box 644. The base 2 is further provided with a second insertion slot 271, a third insertion slot 272, and a fourth insertion slot 273. The second mounting box 643 is inserted inside the second insertion slot 271, and the second mounting box 643 is connected to the base 2 via a third connecting member. The third mounting box 644 is inserted into the third insertion slot 272, and the third mounting box 644 is connected to the base 2 via a fourth connecting member. The third infrared detection device 65 is arranged inside the fourth mounting box 651. The fourth mounting box 651 is inserted into the fourth insertion slot 273, and the fourth mounting box 651 is connected to the base 2 via a fifth connecting member. Through the above structure, the modular design of the first infrared detection device 6 and the second infrared detection device 64 is achieved, thereby facilitating the installation of the first infrared detection device 6 and the second infrared detection device 64 by the user.

In the present embodiment, the pet toilet further includes a waste collection box 7, and the waste collection box 7 is arranged below the base 2. The waste collection box 7 is provided with a waste collection space 71 and a collection opening 72, and the collection opening 72 is in communication with the waste collection space 71. The pet toilet further includes a sealing door 73, and the sealing door 73 is arranged at the collection opening 72 to open or close the collection opening 72. A first magnetic attraction member 731 is arranged on the sealing door 73, and a second magnetic attraction member 732 is arranged on the waste collection box 7. When the sealing door 73 covers the collection opening 72, the first magnetic attraction member 731 and the second magnetic attraction member 732 are magnetically attracted to each other, so as to close the sealing door 73 to cover the collection opening 72 by magnetic attraction. When the first opening 11 rotates along with the roller 1 from the initial position to the discharge position, the pet litter can enter the second accommodating space 31 through the sifting assembly 3, the excreta is limited outside the second accommodating space 31, the driving device 4 drives the sealing door 73 to open the collection opening 72, and the first opening 11 rotates with the roller 1 to align with the second opening 28 and the collection opening 72, so that the excreta is discharged into the waste collection space 71 through the first opening 11 and the collection opening 72 under its own gravity. When the first opening 11 rotates along with the roller 1 from the discharge position to the initial position, the first opening 11 is misaligned with the collection opening 72 and the second opening 28, the pet litter in the second accommodating space 31 can pass through the sifting assembly 3 and fall back into the first accommodating space 111 under its own gravity, and the driving device 4 drives the sealing door 73 to close the collection opening 72. Through the above structure, when the driving device 4 drives the sealing door 73 to close the collection opening 72, the first magnetic attraction member 731 and the second magnetic attraction member 732 mutually attract each other, so as to close the sealing door 73 to cover the collection opening 72 by magnetic attraction, so that the sealing door 73 is capable of accurately covering the collection opening 72 to prevent odor from leaking out through the collection opening 72. Under normal circumstances, the sealing door 73 is driven by the driving device 4 to close. However, in many cases, due to precision issues, the sealing door 73 often fails to accurately cover the collection opening 72, resulting in a certain gap between the sealing door 73 and the collection opening 72. Through mutual magnetic attraction between the first magnetic attraction member 731 and the second magnetic attraction member 732, the sealing door 73 can be pulled to fully cover the collection opening 72 by magnetic attraction, so as to eliminate the gap between the sealing door 73 and the collection opening 72.

In the present embodiment, the driving device 4 includes a driving assembly 41 and a transmission assembly 42. The driving device 4 is configured for driving the roller 1 to rotate on the base 2. When the first opening 11 rotates along with the roller 1 from the initial position to the discharge position, the roller 1 drives the sealing door 73 through the transmission assembly 42 to open the collection opening 72, and the first opening 11 rotates along with the roller 1 to align with the collection opening 72, so that the excreta can be discharged into the waste collection space 71 through the first opening 11 and the collection opening 72 under its own gravity. When the first opening 11 rotates along with the roller 1 from the discharge position to the initial position, the pet litter in the second accommodating space 31 can pass through the sifting assembly 3 and fall back into the first accommodating space 111 under its own gravity, and the roller 1 drives the sealing door 73 through the transmission assembly 42 to close the collection opening 72. The transmission assembly 42 includes a first transmission member 421 and a second transmission member 422. The first transmission member 421 is positioned on an outer side wall of the roller 1, and the second transmission member 422 is positioned on the sealing door 73. When the first opening 11 rotates along with the roller 1 to the discharge position from the initial position, the first transmission member 421 is drivingly connected to the second transmission member 422. The rotation of the roller 1 drives the first transmission member 421 to rotate, and the first transmission member 421 rotates to drive the second transmission member 422 to move, so that the sealing door 73 moves along with the second transmission member 422 to open the collection opening 72. The first opening 11 rotates along with the roller 1 to align with the collection opening 72, so that the excreta can be discharged into the waste collection space 71 through the first opening 11 and the collection opening 72 under its own gravity. When the first opening 11 rotates along with the roller 1 from the discharge position to the initial position, the first transmission member 421 is drivingly connected to the second transmission member 422. The pet litter in the second accommodating space 31 can pass through the sifting assembly 3 and fall back into the first accommodating space 111 under its own gravity. The rotation of the first transmission member 421 drives the second transmission member 422 to move, so that the sealing door 73 moves along with the second transmission member 422 to close the collection opening 72. Specifically, a sliding rail 74 is arranged on the waste collection box 7. The rotation of the roller 1 drives the first transmission member 421 to rotate, and the rotation of the first transmission member 421 drives the second transmission member 422 to move, so that the sealing door 73 slides along with the second transmission member 422 on the sliding rail 74 to open or close the collection opening 72. Furthermore, the first transmission member 421 is an arc-shaped first rack arranged along an outer wall of the roller 1. The sealing door 73 is in a flat shape. The second transmission member 422 is a flat shaped second rack arranged on the sealing door 73. The sliding rail 74 is in a flat shape. The rotation of the roller 1 drives the first rack to rotate, and the first rack drives the second rack to move, so that the sealing door 73 slides along with the second rack on the sliding rail 74 to open or close the collection opening 72. Through the above structure, the arrangement of the driving device 4 is effectively achieved. The driving assembly 41 drives the roller 1 to rotate on the base 2. The rotation of the roller 1 drives the first rack to rotate. When the roller 1 rotates from the initial position to the discharge position, the first rack meshes with the second rack, so that the first rack drives the second rack to move, the sealing door 73 slides along with the second rack on the sliding rail 74 to open the collection opening 72, and the sealing door 73 slides along with the second transmission member 422 on the sliding rail 74 to open the collection opening 72, so that the excreta can be discharged into the waste collection space 71 of the waste collection box 7 under its own gravity through the first opening 11, the second opening 28 and the collection opening 72. When the roller 1 rotates from the discharge position to the initial position, the first opening 11 rotates to be misaligned with the collection opening 72 and the second opening 28, and the first rack meshes with the second rack to drive the second rack to move, so that the sealing door 73 slides along with the second rack on the sliding rail 74 to close the collection opening 72, thereby preventing the odor of the excreta from spreading into the living environment.

In the present embodiment, the driving assembly 41 includes a drive motor 411, a driving gear 412, and a driven gear 413. The drive motor 411 is provided with a drive shaft, and the driving gear 412 is arranged on the drive shaft. The driven gear 413 is arranged on the roller 1, and the driven gear 413 meshes with the driving gear 412, so that the rotation of the drive shaft drives the driving gear 412 to rotate, the rotation of the driving gear 412 drives the driven gear 413 to rotate, and the rotation of the driven gear 413 drives the roller 1 to rotate on the base 2. Through the above structure, the driving gear 412 drives the driven gear 413 to rotate, so as to drive the roller 1 to rotate, so that the roller 1 is rotatable between the initial position and the discharge position. The pet toilet further includes a motor mounting bracket 4112. The motor mounting bracket 4112 is detachably connected to the base, and the motor mounting bracket 4112 locks the drive motor to the base.

In the present embodiment, a mounting groove 2212 is further provided below the first supporting groove 221. The mounting groove 2212 is in communication with the first supporting groove 221. The driving gear 412 is arranged inside the mounting groove 2212, and an inner wall of the mounting groove 2212 is provided with a fourth opening 2213. The mounting groove 2212 is in communication with the outside through the fourth opening 2213. Through the above structure, if pet litter enters the first supporting groove 221 and the mounting groove 2212, the pet litter can be discharged to the outside through the fourth opening 2213, effectively preventing the pet litter from blocking the first supporting groove 221 and the mounting groove 2212. Therefore, this can prevent the pet litter from jamming the driving gear 412 and driven gear 413 due to accumulation of the pet litter, thereby allowing the roller 1 to rotate more smoothly on the supporting portions. In the present embodiment, the waste collection box 7 is further provided with a first clearance groove 75. The first clearance groove 75 is configured for providing clearance for the first rack and the second rack. Through the above structure, the first clearance groove 75 is capable of providing clearance for the first rack and the second rack, allowing the second rack and the sealing door 73 to slide more smoothly on the sliding rail 74, and also allowing the first rack to rotate more smoothly along with the roller 1 to drive the second rack and the sealing door 73 to slide.

In the present embodiment, the waste collection box 7 includes a collection chamber 76 and a first mounting cover 77. The waste collection space 71 is provided in the collection chamber 76. The collection opening 72 is defined in the first mounting cover 77. The first mounting cover 77 is detachably connected to the collection chamber 76. The sealing door 73 is connected to the first mounting cover 77, and the sealing door 73 is capable of sliding on the first mounting cover 77 to open or cover the collection opening 72. The collection chamber 76 is provided with a first hanging portion 761 and a second hanging portion 762. The first hanging portion 761 and/or the second hanging portion 762 is an elastic hanging portion. The first hanging portion 761 is configured for hanging a first end of a drawstring waste bag, and the second hanging portion 762 is configured for hanging a second end of the drawstring waste bag. Through the above structure, the first hanging portion 761 and/or the second hanging portion 762 is an elastic hanging portion, and the first hanging portion 761 and/or the second hanging portion 762 is capable of undergoing elastic deformation by pulling a drawstring of the drawstring waste bag, so that the drawstring waste bag is capable of detaching from the first hanging portion 761 and/or the second hanging portion 762. Furthermore, the first end of the drawstring waste bag is pulled to move toward the second end to close a bag opening of the drawstring waste bag, thereby preventing the odor of the excreta in the waste bag from leaking out.

In the present embodiment, the first mounting cover 77 is provided with a drawstring opening 771. The drawstring opening 771 is in communication with the waste collection space 71 of the collection chamber 76. The drawstring opening 771 is configured for the drawstring of the drawstring waste bag to be threaded out of the collection chamber 76 and the first mounting cover 77. Through the above structure, since the drawstring opening 771 is provided, the drawstring of the drawstring waste bag can be pulled without opening the first mounting cover 77 to allow the first hanging portion 761 and/or the second hanging portion 762 to undergo elastic deformation, so that the drawstring waste bag can be separated from the first hanging portion 761 and/or the second hanging portion 762. In addition, the first end of the drawstring waste bag is enabled to move toward the second end to close the bag opening of the drawstring waste bag, thereby preventing the odor of the excreta in the waste bag from leaking out. After that, the first mounting cover 77 is opened to remove the waste bag. It is not only easy to replace the drawstring waste bag, but also during the entire replacement process, the odor of the excreta in the drawstring waste bag will not leak out, further improving user experience. In particular, a snap-fit cover 7711 is provided at the drawstring opening 771. The snap-fit cover 7711 detachably covers the drawstring opening 771, enabling the user to open the snap-fit cover, so as to open the drawstring opening and pull the drawstring of the drawstring waste bag.

In the present embodiment, the pet toilet further includes a third locking catch 78 and a third elastic member 781. The third locking catch 78 includes a third connecting end 782, a third locking hook end 783, and a third pushing end 784. The third connecting end 782 is arranged between the third locking hook end 783 and the third pushing end 784. The third connecting end 782 is rotatably connected to the first mounting cover 77. A lower side of the base 2 is provided with a stop edge 201. The third elastic member 781 is sleeved on the third locking catch 78, and the third elastic member 781 pushes and presses the third locking hook end 783 against the stop edge 201, so that the stop edge 201 stops the waste collection box 7 below the base 2. Under an action of external force, the third pushing end 784 is capable of pushing the third locking hook end 783 to rotate and detach from the stop edge 201. Through the above structure, by pushing the third pushing end 784, the third locking hook end 783 is capable of rotating and detaching from the stop edge 201, making it easy for the user to remove the waste collection box 7 and clean the waste collection box 7. After cleaning, the waste collection box 7 is pushed to a position below the base 2 and is retained below the base 2 via the stop edge 201 and the third locking hook end 783.

In the present embodiment, the waste collection box 7 further includes a decorative cover 79. The decorative cover 79 is detachably connected to the first mounting cover 77, and the decorative cover 79 is capable of retaining the sealing door 73 on the first mounting cover 77. The sliding rail 74 is arranged on the first mounting cover 77. Through the above structure, the installation of the sealing door 73 is effectively achieved, enabling the sealing door 73 to stably slide on the first mounting cover 77.

In the present embodiment, a lower side of the first mounting cover 77 is provided with a deodorization box mounting groove 772. The deodorization box mounting groove 772 is configured for mounting a deodorization box. Through the above structure, the deodorization box is capable of eliminating the odor of the excreta in the waste collection box 7. Moreover, by mounting the deodorization box in the mounting groove, it is convenient for the user to replace the deodorization box.

In the present embodiment, the pet toilet further includes support feet 8. The support feet 8 are detachably connected to the base 2. The support feet 8 include mounting portions 81 and supporting portions 82. Upper sides of the mounting portions 81 are detachably connected to the base 2, and lower sides of the mounting portions 81 are detachably connected to the supporting portions 82. Through the above structure, due to the detachable connection between the support feet 8 and the base 2, it is easy to install, replace, and disassemble the support feet 8. By disassembling the support feet 8, it is convenient for transportation. Furthermore, since the mounting portions 81 and the supporting portions 82 are detachable, the support feet 8 can be further disassembled for easier transportation. Additionally, the supporting portions 82 and the mounting portions 81 can be separately formed, making it convenient for producing, thereby improving production efficiency and yield.

In the present embodiment, lower sides of the mounting portions 81 are provided with mounting annular grooves 811. The supporting portions 82 are provided with annular mounting protrusions 821. The mounting protrusions 821 are connected to the mounting annular grooves 811. Each mounting portion 81 includes a left housing 812 and a right housing 813. The left housing 812 is provided with a left annular groove 8121, and the right housing 813 is provided with a right annular groove 8131. Each left housing 812 is detachably connected to a respective right housing 813, so that the left housing 812 and the right housing 813 are assembled into one piece. Each left annular groove 8121 is combined with a respective right annular groove 8131 to form a mounting annular groove 811. Specifically, the mounting portions 81 of the support feet 8 are engaged with the base 2. Furthermore, the base 2 is provided with insertion openings 202, and inner walls of the insertion openings 202 are provided with a plurality of notches 2021. Outer side walls of the mounting portions 81 of the support feet 8 are provided with a plurality of snap-fit members 814. When the mounting portions 81 of the support feet 8 are inserted into the insertion openings 202, the snap-fit members 814 are connected to the notches 2021 to assemble the support feet 8 to the base 2 into one piece. Furthermore, lower sides of the snap-fit members 814 are connected to the outer side walls of the mounting portions 81 of the support feet 8. A slit 815 is provided between the snap-fit members 814 and the outer side walls of the mounting portions 81 of the support feet 8. The slit 815 surrounds an upper side, a left side, and a right side of the snap-fit member 814. Furthermore, the insertion openings 202 are further provided with first guiding portions 2022, and the mounting protrusions 81 of the support feet 8 are also provided with second guiding portions 816. When the support feet are inserted into the insertion openings 202, the first guiding portions 2022 slide along the second guiding portions 816 to connect the snap-fit members 814 to the notches 2021, and the support feet 8 are combined with the base 2 to form an integral unit. Furthermore, the first guiding portions 2022 are guiding blocks arranged on the inner walls of the insertion openings 202, and the second guiding portions 816 are guiding grooves provided on the side walls of the mounting protrusions 81 of the support feet 8. The supporting portions 82 are arranged at an obtuse angle to the mounting portions 81. Through the above structure, the connection between the mounting portions 81 and the supporting portions 82 is effectively achieved, and the connection between the mounting portions 81 and the base 2 is achieved.

In the present embodiment, the pet toilet further includes a sealing plate 203. The sealing plate 203 is detachably connected to a lower side of the base 2. The sealing plate 203 is configured for covering a mounting gap 204 between the support feet 8 and a side wall of the base 2. Through the above structure, the sealing plate 203 is capable of covering the mounting gap 204 between the support feet 8 and the side wall of the base 2, so that the pet is prevented from getting into the mounting gap 204 between the support feet 8 and the side wall of the base 2, and the lower side of the base 2 is flatter and more aesthetically pleasing. The sealing plate 203 is configured for covering the chassis insertion slot 53, the second insertion slot 271, the third insertion slot 272, and the fourth insertion slot 273. Through the above structure, the sealing plate 203 covers the chassis insertion slot 53, the second insertion slot 271, the third insertion slot 272, and the fourth insertion slot 273. Therefore, this not only makes the base 2 more aesthetically pleasing, but also can protect the chassis 5, the second infrared detection device 64, and the third infrared detection device 65 respectively inserted in the chassis insertion slot 53, the second insertion slot 271, the third insertion slot 272, and the fourth insertion slot 273.

In the present embodiment, the first accommodating space 111 is provided with a plurality of protruding ribs 1111. The pet toilet further includes a pad body 1112. The pad body 1112 detachably covers the protruding ribs 1111 and a bottom surface of the first accommodating space 111. Through the above structure, the protruding ribs 1111 are capable of supporting the pad body 1112, so that the pad body 1112 is higher than the bottom surface of the first accommodating space 111. Therefore, the pet litter can be placed on the pad body 1112 to reduce a capacity of the first accommodating space 111, making it convenient for the user to adjust an amount of the pet litter. When a large amount of pet litter is needed, the pad body 1112 is detached, so that the pet litter is directly contained on the bottom surface of the first accommodating space 111, so as to increase the capacity of the first accommodating space 111.

In the present embodiment, a protruding annular leak-proof ring 1113 is provided in the first accommodating space 111. The annular leak-proof ring 1113 is configured for retaining the pet’s excreta within the first accommodating space 111. Through the above structure, when the roller 1 rotates, the annular leak-proof ring 1113 can prevent urine and other excrement in the first accommodating space 111 from permeating out of the first accommodating space 111.

The first accommodating space 111 is further provided with an annular stopping protrusion 1114. The stopping protrusion 1114 abuts against an upper side of the annular leak-proof ring to retain the annular leak-proof ring 1113 within the first accommodating space 111. A lower side of the annular leak-proof ring 1113 abuts against an edge of the pad body 1112 to retain the pad body 1112 within the first accommodating space 111. Specifically, a retaining groove 1115 is formed between the lower side of the annular leak-proof ring 1113 and an inner wall of the first accommodating space 111. The lower side of the annular leak-proof ring 1113 retains the edge of the pad body 1112 within the retaining groove 1115. Through the above structure, the design is reasonable, the structure is simple, and the arrangement of the pad body 1112 and the annular leak-proof ring 1113 is effectively achieved.

In the present embodiment, the waste collection box 7 is provided with a first outer side wall 70 and a first bottom wall 701. The first bottom wall 701 is connected to the first outer side wall 70, and a distance between a first side of the first bottom wall 701 and a bottom end of the first outer side wall 70 is a first distance. A distance between a second side of the first bottom wall 701 and the bottom end of the first outer side wall 70 is a second distance, and the first distance is different from the second distance, so that the first bottom wall 701 is arranged at an inclined angle. Through the above structure, when the excreta is discharged into the waste collection space 71 of the waste collection box 7 through the collection opening 72, the excreta slides along an inclined surface from the second side of the first bottom wall 701 to the first side of the first bottom wall 701, so as to prevent accumulation of the excreta on the second side of the first bottom wall 701 below the collection opening 72.

In the present embodiment, a middle portion of the sifting assembly 3 is recessed toward an inner wall of the roller 1 to form a guiding channel 32. Through the above structure, the excreta can be conveniently discharged into the waste collection box 7 along the guiding channel 32 through the first opening 11 and the collection opening 72.

The sifting assembly 3 includes a first portion 33 and a second portion 34. The first portion 33 is connected to the roller 1. The second portion 34 is connected to the first portion 33, and the second portion 34 is positioned between the first accommodating space 111 and the first portion 33. A plurality of screen holes 341 are defined in the second portion 34. Specifically, a depth of the guiding channel 32 increases from the second portion 34 to the first portion 33, and a width of the guiding channel 32 decreases from the second portion 34 to the first portion 33. Furthermore, the first portion 33 includes a first baffle 331 and a second baffle 332. A first side of the first baffle 331 is connected to the second portion 34, and a middle portion of a second side of the first baffle 331 is connected to a middle portion of the roller 1. Two ends of the second side of the first baffle 331 are connected to two ends of the roller 1 via the second baffle 332. The second baffle 332 is arranged at an acute angle, a right angle, or an obtuse angle to the first baffle 331. Meanwhile, the second baffle 332 can serve to block the pet litter, thereby preventing the pet litter from splashing into the external environment when the roller 1 rotates.

In the present embodiment, the first connecting member, the second connecting member, the third connecting member, the fourth connecting member, and the fifth connecting member are all screws or bolts. The first elastic member, the second elastic member, and the third elastic member are all torsional springs.

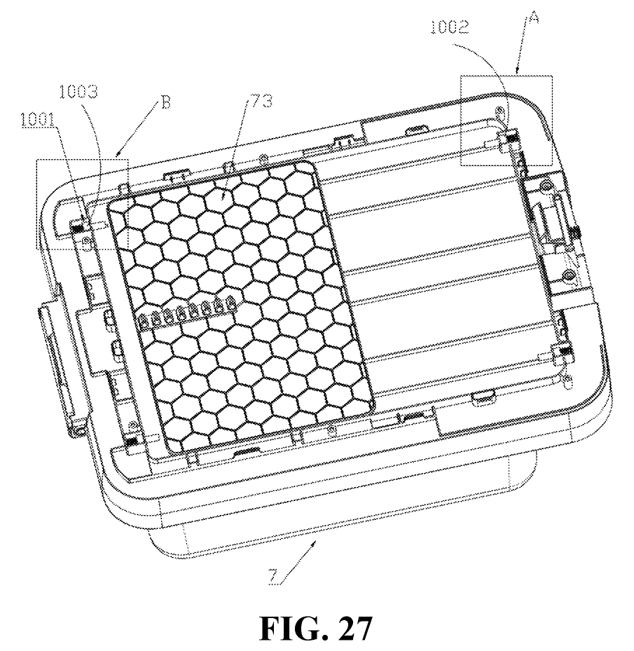

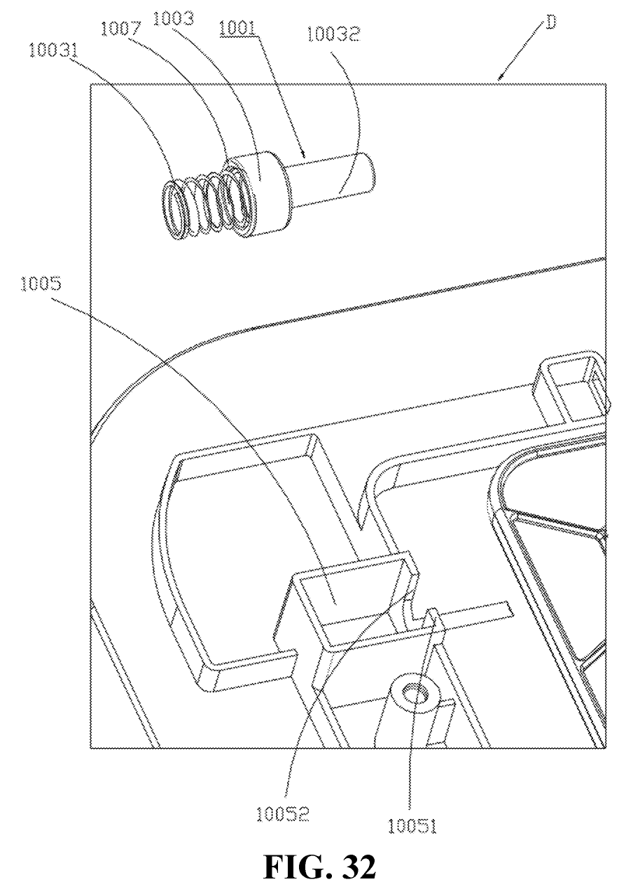

Referring to FIG. 27 - FIG. 32, the present disclosure further provides a pet toilet.

The pet toilet includes a roller. The roller is provided with a first opening and a first accommodating space. The first opening is in communication with the first accommodating space, and the first accommodating space is configured for accommodating pet excreta and pet litter.

The pet toilet further includes a base, and the roller is supported by the base.

The pet toilet further includes a sifting assembly, and the sifting assembly is connected to the roller. The sifting assembly and an inner wall of the roller together define a third accommodating space. The third accommodating space is adjacent to the first accommodating space. The sifting assembly is configured for separating the pet litter from the excreta.

The pet toilet further includes a driving device, and the driving device is configured for driving the roller to rotate on the base.

The pet toilet further includes a waste collection box. The waste collection box is arranged below the base. The waste collection box is provided with a waste collection space and a collection opening. The collection opening is in communication with the waste collection space.

The pet toilet further includes a sealing door, and the sealing door is arranged at the second opening for opening or closing the second opening. When the first opening rotates along with the roller from the initial position to the discharge position, the pet litter can enter the third accommodating space through the sifting assembly, and the excreta is limited outside the third accommodating space. The driving device drives the sealing door to open the second opening, and the first opening rotates along with the roller to align with the second opening, so that the excreta can be discharged into the second accommodating space through the first opening and the second opening under its own gravity. When the first opening rotates along with the roller from the discharge position to the initial position, the first opening is misaligned with the second opening, the pet litter in the third accommodating space can pass through the sifting assembly and fall back into the first accommodating space under its own gravity, and the driving device drives the sealing door to close the second opening.

The pet toilet further includes an elastic reset device 1001. The elastic reset device 1001 is connected to the sealing door 73 or the waste collection box 7. When the driving device 4 drives the sealing door 73 to open the collection opening 72, the elastic reset device 1001 is configured for pushing the sealing door 73 back to an open position. When the driving device 4 drives the sealing door 73 to close the collection opening 72, the elastic reset device 1001 is configured for pushing the sealing door 73 back to a closed position.

Through the above structure, when the driving device drives the sealing door to close the second opening, the elastic reset device is capable of pushing the sealing door to cover the second opening, so as to accurately push the sealing door to the closed position, so that the sealing door accurately covers the second opening, thereby preventing odor from leaking out through the second opening. Under normal circumstances, the sealing door is driven to close by the driving device. However, in many cases, due to precision issues, the driving device excessively pushes the sealing door, causing a certain gap between the sealing door and the second opening. The elastic reset device is capable of pushing the sealing door to close to cover the second opening, so as to accurately push the sealing door to the closed position. An elastic reset force provided by the elastic reset device can push the sealing door to fully cover the second opening, so as to eliminate the gap between the sealing door and the second opening. When the driving device drives the sealing door to open the second opening, the elastic reset device is capable of pushing the sealing door to open the second opening, so as to accurately push the sealing door to the open position, so that the second opening can be accurately opened by the sealing door. Typically, the sealing door is driven to open by the driving device. However, in many cases, due to precision issues, the driving device may excessively push the sealing door, causing the sealing door to be excessively opened. The elastic reset device is capable of pushing the sealing door back to the original position of the sealing door, thereby accurately pushing the sealing door to the open position. Furthermore, normally, when the driving device drives the sealing door to open or close the second opening, the sealing door is prone to deviation or misalignment during pushing, causing the position of the sealing door to shift. The elastic reset device can correct the position of the sealing door by pushing it, so that the sealing door can operate stably.

In the present embodiment, the elastic reset device 1001 includes a first elastic reset assembly 1002 and a second elastic reset assembly 1003. A first end of the first elastic reset assembly 1002 is connected to a first side of the waste collection box. When the driving device 4 drives the sealing door 73 to open the collection opening 72, a second end of the first elastic reset assembly 1002 pushes the sealing door back to the open position. A first end of the second elastic reset device 1001 is connected to a second side of the waste collection box. When the driving device 4 drives the sealing door 73 to close the collection opening 72, a second end of the second elastic reset assembly 1003 pushes the sealing door back to the closed position. The first elastic reset assembly 1002 include a first spring member 10021 and a first ejector pin 10022. The first spring member 10021 is connected to the first side of the waste collection box, and the first ejector pin 10022 is connected to the first spring member 10021. The second elastic reset assembly 1003 include a second spring member 10031 and a second ejector pin 10032. The second spring member 10031 is connected to the second side of the waste collection box, and the second ejector pin 10032 is connected to the second spring member 10031. Specifically, the waste collection box is provided with a first mounting groove 1004 and a second mounting groove 1005. A first end of the first spring member 10021 abuts against a first side of an inner wall of the first mounting groove 1004. A first end of the first ejector pin 10022 is provided with a first fitting hole 1006. A second end of the first spring member 10021 is connected to the first fitting hole 1006. A second side of the inner wall of the first mounting groove 1004 is provided with a first stopping portion 10041 and a first notch 10042. The first stopping portion 10041 retains the first end of the first ejector pin 10022 in the first mounting groove 1004, and a second end of the first ejector pin 10022 passes out of the first mounting groove 1004 through the first notch 10042. When the driving device 4 drives the sealing door 73 to open the collection opening 72, the second end of the first ejector pin 10022 pushes the sealing door back to the open position. A first end of the second spring member 10031 abuts against a first side of an inner wall of the second mounting groove 1005. A first end of the second ejector pin 10032 is provided with a second fitting hole 1007. A second end of the second spring member 10031 is connected to the second fitting hole 1007. A second side of the inner wall of the second mounting groove 1005 is provided with a second stopping portion 10051 and a second notch 10052. The second stopping portion 10051 retains the first end of the second ejector pin 10032 in the second mounting groove 1005, and a second end of the second ejector pin passes out of the second mounting groove 1005 through the second notch 10052. When the driving device 4 drives the sealing door 73 to close the collection opening 72, the second end of the second ejector pin 10032 pushes the sealing door back to the closed position. Furthermore, a total number of the first elastic reset assembly 1002 is at least two, and at least two first elastic reset assemblies 1002 are uniformly arranged along the first side of the waste collection box in sequence. A total number of the second elastic reset assembly 1003 is at least two, and at least two second elastic reset assemblies 1003 are uniformly arranged along the second side of the waste collection box in sequence. Through the above structure, the arrangement of the first elastic reset device and the second elastic reset device is effectively achieved. The sealing door can be precisely pushed to the open position via the first elastic reset device, and the sealing door can be precisely pushed to the closed position via the second elastic reset device. The first elastic device and the second elastic device can correct a position of the sealing door and can prevent the position of the sealing door from being misaligned.

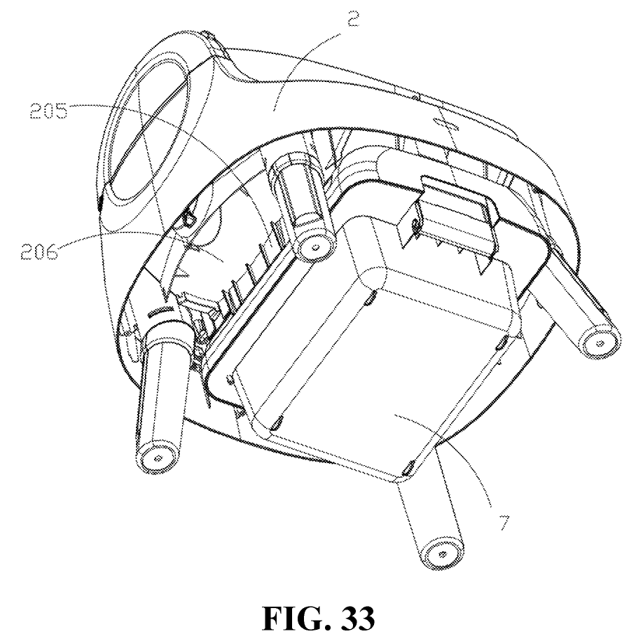

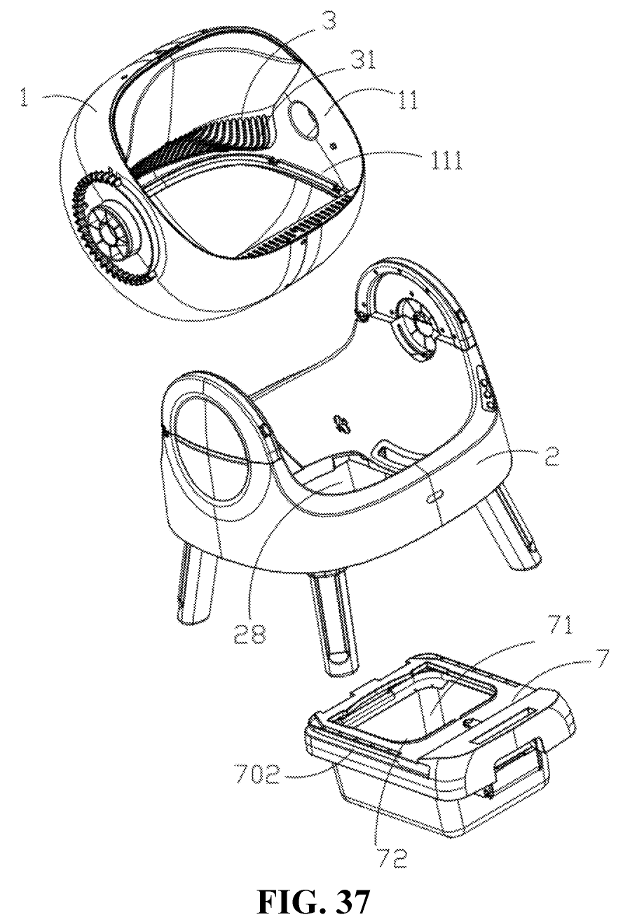

Referring to FIG. 33 - FIG. 37, the present disclosure further provides a pet toilet.

The pet toilet includes a roller 1. The roller 1 is provided with a first opening 11 and a first accommodating space 111, and the first opening 11 is in communication with the first accommodating space 111. The first accommodating space 111 is configured for accommodating excreta of pets and pet litter.

The pet toilet further includes a base 2. The roller 1 is supported by the base 2, and the base 2 is further provided with a second opening 28.

The pet toilet further includes a sifting assembly 3. The sifting assembly 3 is connected to the roller 1. A second accommodating space 31 is surrounded and defined by the sifting assembly 3 and an inner wall of the roller 1. The second accommodating space 31 is adjacent to the first accommodating space 111. The sifting assembly 3 is configured for separating the pet litter from the excreta.

The pet toilet further includes a driving device 4. The driving device 4 is configured for driving the roller 1 to rotate on the base 2. When the first opening 11 rotates along with the roller 1 from an initial position to a discharge position, the pet litter is capable of entering the second accommodating space 31 through the sifting assembly 3, and the excreta is confined outside the second accommodating space 31. The first opening 11 is configured to rotate along with the roller 1 to be aligned with the second opening 28, and the first opening 11 is in communication with the second opening 28, thereby allowing the excreta to be discharged through the first opening 11 and the second opening 28 under its own gravity. When the first opening 11 rotates along with the roller 1 from the discharge position to the initial position, the first opening 11 is misaligned with the second opening 28, and the second opening 28 is covered by the roller 1. In addition, the pet litter inside the second accommodating space 31 is capable of passing through the sifting assembly 3 and falling back into the first accommodating space 111 under its own gravity.

The base 2 is provided with a surrounding wall 205 extending downward from a peripheral edge of the second opening 28. A mounting cavity 206 for accommodating electronic components is surrounded and defined by an outer side wall of the surrounding wall 205 and a bottom wall of the base 2. The surrounding wall 205 is provided with a mounting structure 207, and the mounting structure 207 is configured for mounting a waste collection box 7. When the waste collection box 7 is connected to the mounting structure 207, a collection opening 72 of the waste collection box 7 is in communication with the second opening 28. The surrounding wall 205 cooperates with an outer side wall of the waste collection box 7 to isolate the mounting cavity 206 from a waste collection space 71 of the waste collection box 7 and the second opening 28, thereby preventing gas in the waste collection space 71 from entering the mounting cavity 206.

Through the above structure, when the waste collection box 7 is mounted at the base 2, the outer side wall of the surrounding wall 205 cooperates with the outer side wall of the waste collection box 7, so as to isolate the mounting cavity 206 from the waste collection space 71 of the waste collection box 7 and the second opening 28. This can effectively prevent odorous gas and moisture generated in the waste collection space 71 from entering the mounting cavity 206, and further can reduce the risk of contamination, dampness, and corrosion of the electronic components, thereby improving the operational stability and service life of the electronic components.

In the present embodiment, the surrounding wall 205 includes a first side wall 208, a second side wall 209, a third side wall 210, and a fourth side wall 211 connected in sequence. The first side wall 208 and the third side wall 210 are arranged opposite to each other. The second side wall 209 and the fourth side wall 211 are arranged opposite to each other. The mounting cavity 206 is surrounded and defined by the first side wall 208, the second side wall 209, the third side wall 210, the fourth side wall 211, and the bottom wall of the base 2. The mounting structure 207 is arranged on two opposite side walls of the surrounding wall 205. Through the above structure, the first side wall 208, the second side wall 209, the third side wall 210, and the fourth side wall 211 together with the bottom wall of the base 2 surround and define the mounting cavity 206, thereby providing an independent mounting space for circuit boards, sensors, and other electronic components. Additionally, by arranging the mounting structure 207 on two opposite side walls of the surrounding wall 205, the waste collection box 7 can be stably mounted below the base 2, so that the surrounding wall 205 cooperates with the outer side wall of the waste collection box 7 to form an isolation structure. Therefore, this effectively reduces gas in the waste collection box 7 from entering the mounting cavity 206, and improves the operational reliability and service life of the electronic components.

In the present embodiment, the surrounding wall 205 is integrally formed with the base 2. Through the above structure, this can reduce assembly processes between the surrounding wall 205 and the base 2, lower the number of components, and reduce production costs. Additionally, the integrally formed surrounding wall 205 and the base 2 have higher connection strength, thereby helping to improve the structural stability of the mounting cavity 206.

In the present embodiment, the mounting structure 207 is connected to a sliding rail structure 212, and the waste collection box 7 is provided with a sliding groove 702 cooperating with the sliding rail structure 212. The sliding rail structure 212 is slidably engaged with the sliding groove 702, so that the waste collection box 7 is slidably mounted at the base 2. Through the above structure, this can guide the installation path of the waste collection box 7, making it convenient for the user to quickly mount the waste collection box 7 below the base 2. Additionally, the cooperation between the sliding rail structure 212 and the sliding groove 702 can improve the installation stability of the waste collection box 7, thereby preventing the waste collection box 7 from shaking or shifting.

In the present embodiment, the mounting structure 207 is integrally formed with the sliding rail structure 212. Through the above structure, this can prevent the connection between the mounting structure 207 and the sliding rail structure 212 from becoming loose, which would otherwise affect the installation stability of the waste collection box 7, thereby improving the reliability of the sliding rail structure 212 when bearing the weight of the waste collection box 7 and the pulling force during drawing.

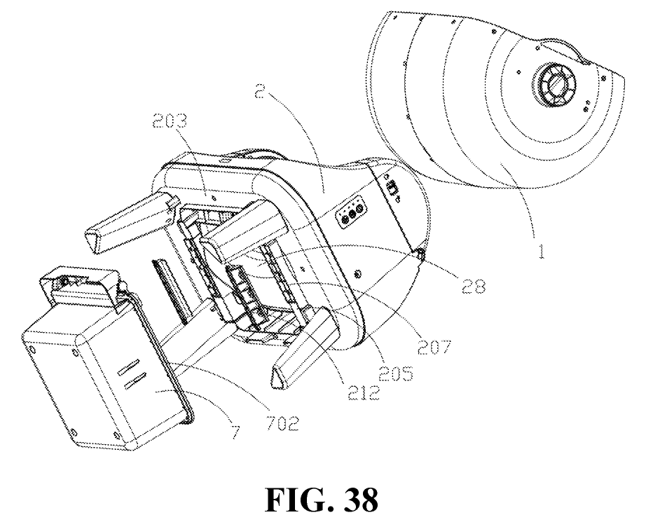

In another embodiment, as shown in FIG. 38, the mounting structure 207 is detachably connected to the sliding rail structure 212. Further, the mounting structure 207 is detachably connected to the sliding rail structure 212 via screws. Through the above structure, the assembly and disassembly of the mounting structure 207 and the sliding rail structure 212 can be facilitated. Moreover, sliding rail structures 212 of different sizes can be replaced according to the installation requirements of waste collection boxes 7 of different specifications, thereby improving the adaptability of the pet toilet to different models of waste collection boxes 7. At the same time, when the sliding rail structure 212 is worn or damaged, the sliding rail structure 212 can be separately replaced without the need to replace the entire mounting structure 207, thereby reducing maintenance costs and improving the flexibility in use of the product.

In the present embodiment, a plurality of reinforcing ribs 213 are spaced apart on a side wall of the surrounding wall 205. The reinforcing ribs 213 extend along a height direction of the surrounding wall 205. Through the above structure, the structural strength and deformation resistance of the surrounding wall 205 can be improved, thereby reducing the occurrence of bending deformation of the surrounding wall 205 when bearing the weight of the waste collection box 7 or being subjected to external forces.

In the present embodiment, the mounting structure 206 extends continuously along a periphery of the second opening 28. Through the above structure, an internal space of the mounting structure 206 can be increased, so as to facilitate the arrangement of circuit boards, sensors, batteries, and other electronic components, thereby improving the space utilization of the mounting structure 206.

In the present embodiment, the pet toilet further includes a sealing plate 203. The sealing plate 203 is mounted to cover the mounting structure 206. The sealing plate 203 is detachably connected to the base 2. Through the above structure, the sealing plate 203, the surrounding wall 205, and the base 2 together define a relatively closed mounting structure 206, so as to reduce gas, dust, and pet litter in the waste collection space 71 from entering the mounting structure 206, thereby reducing the impact of the external environment on the electronic components, and also making the base 2 more aesthetically pleasing.

In another embodiment, the pet toilet further includes the waste collection box 7. The waste collection box 7 is arranged below the base 2 via the mounting structure 207. The waste collection box 7 is provided with the waste collection space 71 and the collection opening 72, and the collection opening 72 is in communication with the waste collection space 71. When the first opening 11 rotates from the initial position to the discharge position along with the roller 1, the pet litter is capable of entering the second accommodating space through the sifting assembly 3, and the excreta is confined outside the second accommodating space. The first opening 11 is configured to rotate to a position where it is aligned with and in communication with the second opening 28 and the collection opening 72, so that the excreta is discharged into the waste collection space 71 through the first opening 11, the second opening 28, and the collection opening 72 under its own gravity. Through the above structure, the rotation of the roller can automatically separate the pet litter from the excreta and can guide the excreta into the waste collection space 71 for centralized collection. Additionally, the waste collection box 7 is mounted on an outer side of the surrounding wall 205, and the surrounding wall 205 cooperates with a side wall of the waste collection box 7 to form an isolation structure, thereby reducing gas in the waste collection space 71 from entering the installation cavity 206. Therefore, this minimizes the influence of odor generated by the excreta on the electronic components in the mounting cavity 206, thereby improving the operational reliability and service life of the electronic components.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A pet toilet comprising:
a roller, the roller defining a first opening and a first accommodating space, the first opening being in communication with the first accommodating space, and the first accommodating space being configured for accommodating excreta of pets and pet litter;
a base, the roller being supported by the base, and the base further defining a second opening;
a sifting assembly, the sifting assembly being connected to the roller, a second accommodating space being surrounded and defined by the sifting assembly and an inner wall of the roller, the second accommodating space being adjacent to the first accommodating space, and the sifting assembly being configured for separating the pet litter from the excreta;
a driving device, wherein the driving device is configured for driving the roller to rotate on the base; when the first opening rotates along with the roller from an initial position to a discharge position, the pet litter is capable of entering the second accommodating space through the sifting assembly, the excreta is confined outside the second accommodating space, the first opening is configured to rotate along with the roller to be aligned with the second opening, and the first opening is in communication with the second opening, thereby allowing the excreta to be discharged through the first opening and the second opening under its own gravity; when the first opening rotates along with the roller from the discharge position to the initial position, the first opening is misaligned with the second opening, the second opening is covered by the roller, and the pet litter inside the second accommodating space is capable of passing through the sifting assembly and falling back into the first accommodating space under its own gravity;
wherein the base is provided with a surrounding wall extending downward from a peripheral edge of the second opening, a mounting cavity for accommodating electronic components is surrounded and defined by the surrounding wall and a bottom wall of the base, the surrounding wall is provided with a mounting structure, and the mounting structure is configured for mounting a waste collection box; when the waste collection box is connected to the mounting structure, a collection opening of the waste collection box is in communication with the second opening, and the surrounding wall cooperates with an outer side wall of the waste collection box to isolate the mounting cavity from a waste collection space of the waste collection box and the second opening, thereby inhibiting gas in the waste collection space from entering the mounting cavity.

2. The pet toilet according to claim 1, wherein the surrounding wall comprises a first side wall, a second side wall, a third side wall, and a fourth side wall connected in sequence, the first side wall and the third side wall are arranged opposite to each other, the second side wall and the fourth side wall are arranged opposite to each other, and the mounting cavity is surrounded and defined by the first side wall, the second side wall, the third side wall, the fourth side wall, and the bottom wall of the base.

3. The pet toilet according to claim 2, wherein the mounting structure is arranged on two opposite side walls of the surrounding wall.

4. The pet toilet according to claim 1, wherein the surrounding wall is integrally formed with the base.

5. The pet toilet according to claim 3, wherein a sliding rail structure is connected to the mounting structure, the waste collection box is provided with a sliding groove cooperating with the sliding rail structure, and the sliding rail structure is slidably engaged with the sliding groove, so that the waste collection box is slidably mounted at the base.

6. The pet toilet according to claim 5, wherein the mounting structure is integrally formed with the sliding rail structure.

7. The pet toilet according to claim 5, wherein the mounting structure is detachably connected to the sliding rail structure.

8. The pet toilet according to claim 7, wherein the mounting structure is detachably connected to the sliding rail structure via screws.

9. The pet toilet according to claim 1, wherein a plurality of reinforcing ribs are spaced apart from each other on a side wall of the surrounding wall, and the reinforcing ribs extend along a height direction of the surrounding wall.

10. The pet toilet according to claim 1, wherein the mounting cavity extends continuously along a periphery of the second opening.

11. The pet toilet according to claim 1, wherein the pet toilet further comprises a sealing plate, and the sealing plate is mounted to cover the mounting cavity.

12. The pet toilet according to claim 11, wherein the sealing plate is detachably connected to the base.

13. The pet toilet according to claim 1, further comprising the waste collection box, wherein the waste collection box is arranged below the base via the mounting structure, the waste collection box is provided with the waste collection space and the collection opening, and the collection opening is in communication with the waste collection space; when the first opening rotates along with the roller from the initial position to the discharge position, the pet litter is capable of entering the second accommodating space through the sifting assembly, the excreta is confined outside the second accommodating space, and the first opening is configured to rotate to a position where it is aligned with and in communication with the second opening and the collection opening, so that the excreta is discharged into the waste collection space through the first opening, the second opening, and the collection opening under its own gravity.

14. The pet toilet according to claim 1, wherein the base includes a main body and a first supporting portion connected to the main body, the first supporting portion is provided with a first supporting groove, and the first supporting groove is configured for supporting the roller; a first supporting shaft is arranged on a first side of the roller, the first supporting shaft is positioned in the first supporting groove, and the first supporting shaft is rotatable in the first supporting groove; the base further comprises a first flip cover, the first flip cover is connected to the first supporting portion, and the first flip cover is configured for covering the first supporting groove, so as to retain the first supporting shaft in the first supporting groove; the first flip cover is further provided with a first retaining groove, the first retaining groove is configured for covering an upper half portion of the first supporting shaft, and the first supporting groove is configured for supporting a lower half portion of the first supporting shaft; the first flip cover is further provided with a first rolling wheel, the first rolling wheel is rotatably arranged at the first flip cover, and the first rolling wheel is arranged in the first retaining groove and abuts against the first supporting shaft.

15. The pet toilet according to claim 14, wherein the base further comprises a second supporting portion connected to the main body, the second supporting portion is provided with a second supporting groove, a second supporting shaft is arranged on a second side of the roller, the second supporting shaft is positioned in the second supporting groove, and the second supporting shaft is rotatable in the second supporting groove.

16. The pet toilet according to claim 14, wherein a plurality of second rolling wheels are arranged in the first supporting groove, and the second rolling wheels are configured for supporting the first supporting shaft.

17. The pet toilet according to claim 16, wherein a wheel frame is arranged in the first supporting groove, and the second rolling wheels are rotatably arranged at the wheel frame.

18. The pet toilet according to claim 17, wherein the second rolling wheels are rotatably connected to the wheel frame via a first rotating shaft.

19. The pet toilet according to claim 17, wherein the wheel frame is arc-shaped, a lower surface of the wheel frame abuts against the first supporting groove, and the plurality of second rolling wheels are uniformly arranged along an upper surface of the wheel frame.

20. The pet toilet according to claim 17, wherein a lower surface of the wheel frame is provided with a first positioning groove, a first positioning protrusion is arranged in the first supporting groove, and the first positioning groove is engaged with the first positioning protrusion.
